(19) United States
(12) Patent Application Publication
(10) Pub. No.: US 2023/0356757 A1
(43) Pub. Date: Nov. 9, 2023

(54) APPARATUS FOR APPLYING A FORCE TO A VEHICLE ON A TRACK

(71) Applicant: LENZ LTD, Edinburgh (GB)

(72) Inventors: Daniel Eduardo CARBONELL, Edinburgh (GB); Hamish Cathcart GEDDES, Edinburgh (GB)

(73) Assignee: LENZ LTD, Edinburgh (GB)

(21) Appl. No.: 18/018,729

(22) PCT Filed: Jul. 30, 2021
(86) PCT No.: PCT/GB2021/051981

§ 371 Date: Jan. 30, 2023

(30) Foreign Application Priority Data
Jul. 30, 2020 (GB) 2011899.8

(51) Int. Cl. B61C 15/04; B60B 19/00; B60B 39/00

(52) U.S. Cl. CPC B61C 15/04; B60B 19/006; B60B 39/00

(57) ABSTRACT

An apparatus for applying a force to a vehicle (2) on a track (4), the apparatus comprising one or more magnets (6), the one or more magnets being rotatably mountable with respect to at least part of the vehicle. The track comprises one or more electrically conductive portions and the magnets are configured such that their rotation relative to the track induces one or more electrical currents in the track, such that a force is applied to the vehicle.

### FIELD OF THE INVENTION

The present invention relates to an apparatus for applying a force to a vehicle on a track, and particularly, but not exclusively, to improving the traction of a vehicle to a track. Other aspects of the invention will become apparent from a reading of the present application.

### BACKGROUND OF THE INVENTION

Vehicles that run on tracks, such as rails, roads, guides, tram tracks, or the like, can suffer from a loss of traction. For example, if a part of the track becomes wet, or covered in debris, a loss of traction can occur, which can lead to the wheel(s) of the vehicle slipping on the track.

A way of mitigating this risk is to configure the wheels of the vehicle to have a higher surface area, or to have better grip with the track. However, the use of such wheels at high speed and under normal traction conditions reduces the efficiency of the vehicle.

The present inventors have appreciated the shortcomings in known methods of improving the traction of a vehicle to a track.

### STATEMENTS OF INVENTION

According to a first aspect of the present invention there is provided an apparatus for applying a force to a vehicle on a track, the apparatus comprising:
one or more magnets, the one or more magnets being rotatably mountable with respect to at least part of the vehicle,
wherein the track comprises one or more electrically conductive portions; and
wherein the magnets are configured such that their rotation relative to the track induces one or more electrical currents in the track, such that a force is applied to the vehicle.

The term track includes any form of track or surface that a vehicle may traverse or follow, including railway tracks or rails, roads, paths, guides, guide members or guide rails, runway for aircraft, tracks for robotic vehicles, and tram lines/tracks.

The vehicle may comprise one or more wheels. The vehicle may be configured to run on, or adjacent to, the track.

The track may include one or more rail members. The vehicle may be configured to run on, or adjacent to, the rail member(s) of the track. The vehicle may be a rail vehicle, such as a train. The vehicle may be a railway locomotive. The vehicle may be a carriage of a rail vehicle. The vehicle may be a tram, street car, or the like. The vehicle may be a fuel-powered vehicle. The vehicle may be an electric vehicle. The vehicle may be a fuel-powered and/or electric vehicle, or a hybrid vehicle. The vehicle may be configured to run on at least a portion of the track. The vehicle may be configured to run adjacent to at least a portion of the track. The vehicle may be configured to run on a rail member, or rail members. The vehicle may be configured to run adjacent to one or more rail members. The vehicle may be configured to run on at least a portion of the track and run adjacent to at least another portion of the track.

The vehicle may be a levitation vehicle, such as a levitation train, maglev train, or the like. The levitation vehicle runs on the track. The track may be a guide for the levitation vehicle. In this arrangement, the levitation vehicle runs on the track but is not in contact with the track. The levitation vehicle may be operable to levitate adjacent to at least a portion of the track.

The vehicle may be an aircraft, aerial vehicle, or the like. The track may form at least a part of a runway for the aircraft, aerial vehicle, or the like. The vehicle may be operable to hover above the track. The vehicle may be operable to take off from, and/or land on, at least a portion of the track.

The vehicle may be a robot, robotic device, robotic system, autonomous vehicle, or the like. The vehicle may be a robotic vehicle.

The track may include one or more inclined portions, sloped portions, undulating portions, ramped portions, and/or flat portions. For example, the track could include flat portions and sloped portions.

The vehicle may be an automotive vehicle. The track may form part of a road surface. The road surface may include one or more electrically conductive portions. The road surface may include one or more metals, and/or one or more ferrous metals.

The track may comprise one or more metallic portions. The track may be a metallic track. The electrically conductive portion(s) of the track may comprise one or more ferrous materials, ferrous metals, one or more metals, and/or one or more alloy materials. The metals may be iron and/or steel, or the like.

The apparatus may be operable to apply magnetic friction between the vehicle and the track. The apparatus may be operable to increase the magnetic friction between the vehicle and the track.

The apparatus may be operable to increase the traction of the vehicle to the track. In this arrangement, the vehicle may be in contact with the track, or it may be suspended relative to the track, or levitated relative to the track, and the apparatus is operable to increase the traction of the vehicle to the track.

The apparatus may be operable to increase the contact friction between one or more surfaces of the vehicle, and/or one or more surfaces of a wheel of the vehicle, and the track.

The apparatus may be a traction control apparatus, or traction assistance apparatus. The apparatus may be operable to increase the adhesion, or grip, of the vehicle to one or more surfaces of the track. The apparatus may be operable to provide propulsion to the vehicle. The apparatus may be operable to provide braking to the vehicle. The apparatus may be operable to provide propulsion or braking to the vehicle. The apparatus may be operable to accelerate the vehicle. The apparatus may be operable to accelerate the vehicle from a stationary position. The apparatus may be operable to decelerate the vehicle. The apparatus may be operable to decelerate the vehicle to a stationary position. The apparatus may be operable to provide braking to the vehicle and to bring the vehicle to a halt.

The apparatus may be operable to provide an attractive force between the vehicle and the track, in accordance with Coulomb's law. The apparatus may be operable to provide a repulsive force between the vehicle and the track, in accordance with Coulomb's law. The apparatus may be operable to provide an attractive and/or repulsive force between the vehicle and the track. The apparatus may be operable to exert a drag force on the vehicle.

The apparatus may comprise a frame member. The, or each, magnet may be locatable on the frame member.

The magnet(s) may be configured such that their rotation relative to the track induces one or more electrical eddy currents in at least a portion of the track. The one or more electrically conductive portions of the track may be arranged such that rotation of the magnets relative thereto induces one or more electrical eddy currents in the, or each, electrically conductive portions of the track. The one or more electrically conductive portions may be arranged to promote the formation of electrical eddy currents therein in response to the magnet(s) rotating relative thereto. The electrically conductive portion(s) of the track may include one or more planar surfaces. The electrically conductive portion(s) of the track may include at least one upper surface located adjacent to the vehicle when the vehicle is located on or adjacent to the track. The upper surface may be a planar surface.

The apparatus may be configured as an eddy current propulsion apparatus. The apparatus may be configured as an eddy current brake apparatus. The apparatus may be configured as an eddy current propulsion and braking apparatus. The apparatus may be configured as an eddy current traction control system. The term eddy currents used in this example refers to electrical eddy currents.

The magnet(s) are configured such that their rotation relative to the track induces one or more electrical currents in the track, in accordance with Faraday's law of induction. The one or more electrical currents in the track create a magnetic field, in accordance with Ampere's circuital law such that a magnetic field is applied to the vehicle. The direction of the induced electrical current and thus the direction of the magnetic field produced by the induced current is determined by Lenz's law. Thus, rotation of the magnets relative to the track applies a force to the vehicle. It will be understood that depending on the properties of the magnet, or magnets, the rate of rotation, the direction of rotation, and the properties of the vehicle, apparatus and track, that the direction and/or magnitude of the force can be variable and can be configured in a number of ways. In this arrangement, the operation of the apparatus results in magnetic friction and/or magnetic attraction between the vehicle and the track.

The apparatus may be operable, in use, to apply a variable, or alternating, magnetic field to the track, which induces a variable, or alternating, electrical current in the track, which in turn provides a variable, or alternating magnetic field to the vehicle, or a wheel thereof, in accordance with Faraday's law of induction, Ampere's circuital law and Lenz's law. In this arrangement, applying a variable or alternating, magnetic field to the track can result in magnetic friction and/or magnetic attraction. It will be appreciated that the variable or alternating magnetic field can be provided by the apparatus by moving the magnet(s) and/or by varying the magnetic properties thereof (e.g. by varying the magnetic field intensity and/or magnetic polarity of the magnet(s)).

The apparatus may be configured to apply a variable magnetic field to the track. The apparatus may be operable to vary the magnetic field strength of the, or each, magnet. The apparatus may be operable to switch the magnetic polarity, or to move the location of the poles of, the, or each, magnet. The apparatus may be operable to vary the magnetic field strength and/or switch the magnetic polarity and/or move the location of the poles of, the, or each, magnet.

The apparatus may be operable to vary the magnetic field strength of at least one of the one or more magnets. The apparatus may be operable to switch the magnetic polarity, or to move the location of the magnetic poles of, at least one of the one or more magnets. The apparatus may be operable to vary the magnetic field strength and/or switch the magnetic polarity and/or move the location of the magnetic poles of at least one of the one or more magnets.

The apparatus may comprise a plurality of magnets. The apparatus may comprise between 1 magnet and 120 magnets, optionally between 1 magnet and 90 magnets, optionally between 1 magnet and 60 magnets, optionally between 1 magnet and 30 magnets, optionally between 1 magnet and 18 magnets, optionally between 1 magnet and 15 magnets optionally between 1 magnet and 12 magnets, optionally between 1 magnet and 9 magnets, optionally between 1 magnet and 8 magnets, optionally between 1 magnet and 6 magnets, optionally between 1 magnet and 4 magnets, optionally between 1 magnet and 3 magnets. The apparatus may comprise a single magnet. The apparatus may comprise two or more magnets, optionally three or more magnets, optionally four or more magnets, optionally eight or more magnets, optionally 12 or more magnets, optionally 18 or more magnets, optionally 30 or more magnets, optionally 60 or more magnets. The apparatus may comprise any suitable number of magnets.

The, or each, magnet includes at least one north pole and at least one south pole.

The, or each, magnet may be configurable between an on state, in which the magnet produces a magnetic field, and an off state, in which the magnet does not produce a magnetic field. At least one of the magnets may be configurable between the on state and the off state. At least one of the magnets may be permanently in the on state. At least one of the magnets may be configurable between the on state and the off state and at least one of the magnets may be permanently in the on state.

The, or each, magnet may be configurable between a plurality of directions of magnetic polarity. The, or each, magnet may be configurable between a first direction of magnetic polarity and a second direction of magnetic polarity. At least one of the magnets may be configurable between a first direction of magnetic polarity and a second direction of magnetic polarity. The apparatus may be operable to switch the magnetic polarity of the, or each magnet between the first direction of magnetic polarity and the second direction of magnetic polarity. The apparatus may be operable to switch the magnetic polarity of at least one of the magnets between the first direction of magnetic polarity and the second direction of magnetic polarity.

The, or each, magnet may be configurable between the on state and the off state, and the apparatus may be operable to switch the magnetic polarity of the, or each, magnet between the first direction of magnetic polarity and the second direction of magnetic polarity. The, or each, magnet may be configurable between the on state and the off state, and the apparatus may be operable to vary the magnetic field strength of the, or each, magnet. The apparatus may be operable to switch the magnetic polarity of the, or each, magnet and the apparatus may be configurable to vary the magnetic field strength of the, or each, magnet. The, or each, magnet may be configurable between the on state and the off state, and the apparatus may be operable to vary the magnetic field strength of the, or each, magnet, and the apparatus may be operable to switch the magnetic polarity of the, or each, magnet.

The apparatus may be operable to configure each magnet between the on state and the off state. The apparatus may be operable to independently configure at least some of the magnets between the on state and the off state. The apparatus may be operable to independently switch each magnet between the first direction of magnetic polarity and the second direction of magnetic polarity. The apparatus may be operable to independently switch at least some of the magnets between the first direction of magnetic polarity and the second direction of magnetic polarity. The apparatus may be operable to independently vary the magnetic field strength of each magnet. The apparatus may be operable to independently vary the magnetic field strength of at least some of the magnets.

The vehicle may comprise an x-axis, a y-axis and a z-axis. The x-axis, y-axis, and the z-axis may be orthogonal. The vehicle may move relative to the track substantially in the direction of the x-axis of the vehicle. The vehicle may be configured to move relative to the track substantially in the direction of the x-axis and/or the y-axis. The vehicle may be configured to move relative to the track in the direction of the z-axis. The vehicle may be configured to move relative to the track substantially in the direction of the x-axis, y-axis, and/or z-axis. The z-axis may be a vertical axis of the vehicle. The vehicle may be operable to fly, hover, or levitate above the track in the direction of the x-axis, y-axis and/or z-axis.

The length of the vehicle may be along the x-axis. The width of the vehicle may be along the y-axis. The height of the vehicle may be along the z-axis.

The wheel(s) of the vehicle may be configured to rotate about the y-axis of the vehicle, the x-axis of the vehicle, and/or the z-axis of the vehicle.

The, or each, wheel of the vehicle may have a plane of rotation. The plane of rotation of the wheel(s) of the vehicle may be an x-z plane of the vehicle, an x-y plane of the vehicle, and/or a y-z plane of the vehicle.

The magnet(s) may be arranged to rotate at least partially about at least one axis of rotation. The axis of rotation of the magnet(s) may be the y-axis of the vehicle, the x-axis of the vehicle, and/or the z-axis of the vehicle. The axis of rotation of the magnet(s) may be co-axial with the axis of rotation of the wheel(s) of the vehicle.

The magnet(s) may have one or more planes of rotation. The magnet(s) may have a single plane of rotation. The plane of rotation of the magnet(s) may be an x-z plane of the vehicle, an x-y plane of the vehicle, and/or a y-z plane of the vehicle. The plane of rotation of the magnet(s) may be substantially co-planar with the plane of rotation of a wheel of the vehicle.

The apparatus may comprise one or more activation zones and one or more deactivation zones. The apparatus may comprise a plurality of activation zones. The apparatus may comprise a plurality of deactivation zones. The, or each, activation zone and the, or each, deactivation zone(s) may be defined by sectors of the plane of rotation of the magnet, or magnets. The activation zone(s) and the deactivation zone(s) may be defined by the rotational angle of the, or each, magnet relative to the plane of rotation of the, or each magnet.

At least one of the activation zone(s) may be arranged within a magnet rotational angle of between 90 degrees and 270 degrees within the plane of rotation of the magnets, optionally between 100 degrees and 260 degrees, optionally between 110 degrees and 250 degrees, optionally between 120 degrees and 210 degrees, optionally between 130 degrees and 200 degrees, optionally between 140 degrees and 190 degrees, optionally between 150 degrees and 180 degrees, optionally between 160 degrees and 170 degrees. The rotational angle may be with respect to the vertical axis of the vehicle.

At least a portion of one of the activation zone(s) may be arranged at a magnet rotational angle of approximately 120 degrees. At least a portion of one of the activation zone(s) may be arranged at a magnet rotational angle of approximately 150 degrees. At least a portion of one of the activation zone(s) may be arranged at a magnet rotational angle of approximately 180 degrees. At least a portion of one of the activation zone(s) may be arranged at a magnet rotational angle of approximately 210 degrees. The rotational angle may be with respect to the vertical axis of the vehicle.

The apparatus may be operable to configure the, or each, magnet in the on state when the, or each, magnet is located within the one or more activation zones. The apparatus may be operable to configure at least one of the magnets to be in the on state when the at least one magnet is located within the one or more activation zones.

The apparatus may be operable to configure the, or each, magnet in the off state when the, or each, magnet is located within the one or more deactivation zones. The apparatus may be operable to configure at least one of the magnets in the off state when the at least one magnet is located within the one or more deactivation zones.

The apparatus may be operable to activate and/or deactivate the, or each, magnet at least once during the rotation of the magnet(s). The apparatus may be operable to activate and deactivate the, or each, magnet a plurality of times during the rotation of the magnet(s). The apparatus may be operable to activate and deactivate the, or each, magnet two or more times, optionally three or more times, during the rotation of the magnet(s).

The apparatus may be configured to activate the, or each, magnet only when the magnet is located in an activation zone. In this arrangement, the magnets located in the activation zone(s) are activated and the magnets located in the deactivation zone(s) are not activated.

The apparatus may be configured to activate the, or each, magnet during at least part of the rotation cycle of the, or each magnet.

The apparatus may be configured to activate the, or each, magnet during the entire rotation cycle of the, or each, magnet. In this example, the magnet(s) are activated at all times, provided the apparatus is in use.

The apparatus may be configured to automatically activate and deactivate the, or each, magnet. The apparatus may comprise a control system, which may be an electronic control system. The control system may be operable to selectively activate the, or each, magnet. The control system may be configured to automatically activate and automatically deactivate the, or each, magnet.

The control system may be configured to automatically activate the, or each, magnet as the, or each, magnet is moved into an activation zone and to deactivate the, or each, magnet as the, or each, magnet is moved into a deactivation zone.

The control system may be mountable to the vehicle. The control system may be located on the vehicle. The control system may be integrated with a control system of the vehicle.

The apparatus may be operable between an on condition and an off condition. In the on condition, the, or each, magnet is active, or can be activated when in an activation zone. In the off condition, the, or each, magnet is inactive, and cannot be activated.

The control system may include a control element. The control element may be operable to switch the apparatus between the on condition and the off condition. The control element may include one or more user input elements. The user input element may be a button, switch, lever, or the like. The user input element may be part of a user interface of a computing device, or the like. The control element may be operable to send the control signal to the control element wirelessly and/or using a wired connection. The control element may be located on, or inside, the vehicle. The control element may be arranged to be accessible by a user of the vehicle, optionally a driver thereof.

The apparatus may be configured to activate a single magnet at any one time. The apparatus may be configured to activate a plurality of magnets at any one time. The apparatus may be configured to activate only two magnets at any one time. The apparatus may be configured to activate two or more magnets at any one time. The apparatus may be configured to activate only three magnets at any one time. The apparatus may be configured to activate three or more magnets at any one time.

The apparatus may comprise a single activation zone and a single deactivation zone. The apparatus may comprise two or more activation zones and two or more deactivation zones. The apparatus may comprise two activation zones and two deactivation zones. The apparatus may comprise three or more activation zones and three or more deactivation zones. The apparatus may comprise three activation zones and three deactivation zones.

The apparatus may comprise one or more activation zones located at a lower region of the vehicle. The apparatus may comprise one or more activation zones located at a lower region of a wheel of the vehicle. The apparatus may comprise one or more activation zones located at a region of the vehicle that is, in use, adjacent to at least a portion of the track. The apparatus may comprise one or more activation zones located at a lower region of the frame member. The apparatus may comprise one or more activation zones located at a region of the of the frame member that is adjacent to at least a portion of the track.

The activation zone(s) may be located at a lower region of the plane of rotation of the magnet(s).

The apparatus may comprise one or more deactivation zones located at an upper region of a wheel of the vehicle. The apparatus may comprise one or more deactivation zones located at an upper region of the frame member of the apparatus.

The apparatus may comprise one or more activation zones located proximal to the track and one or more deactivation zones located distal to the track. The apparatus may comprise one or more activation zones located proximal to the track, one or more deactivation zones located proximal to the track and one or more deactivation zones located distal to the track. At least a part of the activation zone(s) may be located adjacent to the track. At least a part of a deactivation zone(s) may be located adjacent to the track.

The apparatus may be configured such that the, or each, magnet is activated for a shorter period of time than it is deactivated. The apparatus may be configured such at least one magnet is activated for a shorter period of time than it is deactivated. The apparatus may be configured such that the, or each, magnet is deactivated for at least 50% of the rotation cycle of the magnet, optionally for at least 60% of the rotation cycle of the magnet, optionally for at least 70% of the rotation cycle of the magnet, optionally for at least 80% of the rotation cycle of the magnet, optionally for at least 90% of the rotation cycle of the magnet. The apparatus may be configured such that the, or each, magnet is deactivated for the majority of the rotation cycle of the, or each magnet.

The apparatus may comprise a first activation zone. The apparatus may comprise a second activation zone. The apparatus may comprise a first deactivation zone. The apparatus may comprise a second deactivation zone. The first and second activation zones may be located adjacent to each other. The first deactivation zone may be located at one side of the first activation zone. The second deactivation zone may be located between the first and second activation zones. The first deactivation zone may be located at one side of the second activation zone. The first deactivation zone may be located at one side of the first activation zone and at one side of the second activation zone.

The second deactivation zone may be arranged to be smaller in area than the first activation zone. The second deactivation zone may be arranged to be smaller in area than the second activation zone. The second deactivation zone may be arranged to be smaller in area than each of the first and second activation zones. In this arrangement, the deactivation time of the, or each, magnet when located in the second deactivation zone is shorter than the activation time of the, or each, magnet when located in the first and/or second activation zones.

The first activation zone and the second activation zone may be substantially identical in size.

The first deactivation zone may be arranged to cover the majority of the plane of rotation of the magnet(s). The first deactivation zone may be arranged to cover at least the upper region of the plane of rotation of the magnet(s). The first deactivation zone may cover at least the upper 50% of the plane of rotation of the magnet(s). The first deactivation zone may cover at least the upper 50% of the frame member.

The apparatus may comprise a third activation zone. The apparatus may comprise a third deactivation zone. The third deactivation zone may be located between the second activation zone and the third activation zone. The third activation zone may be located between the first deactivation zone and the third deactivation zone. The second and third activation zones may be located adjacent to each other. The third activation zone may be located at one side of the second deactivation zone. The third activation zone may be located at one side of the third deactivation zone.

The third deactivation zone may be arranged to be smaller in area than the third activation zone. The third deactivation zone may be arranged to be smaller in area than the second activation zone. The third deactivation zone may be arranged to be smaller in area than both the second and third activation zones. In this arrangement, the deactivation time of the, or each, magnet when located in the third deactivation zone is shorter than the activation time of the, or each, magnet when in the second and/or third activation zone.

The second activation zone and the third activation zone may be substantially identical in size.

The apparatus may be arranged such that there is a magnet present in at least one activation zone at any one time. The apparatus may be arranged such that there is a magnet present in at least two activation zones at any one time. The apparatus may be arranged such that there is a magnet present in at least three activation zones at any one time.

The first deactivation zone may be arranged to be the largest deactivation zone. The first deactivation zone may be arranged to be larger than the first activation zone, the second activation zone and/or the third activation zone.

The third activation zone may be substantially identical in size to the first activation zone and/or the second activation zone.

One or more of the deactivation zones may be arranged as a short-circuit prevention zone arranged to prevent two or more magnets from being short circuited together. The second deactivation zone may be a short-circuit prevention zone. The third deactivation zone may be a short-circuit prevention zone. The second deactivation zone and the third deactivation zone may be short-circuit prevention zones. The first deactivation zone may be a short-circuit prevention zone.

The, or each, magnet may be configured to be selectively activatable. The apparatus may comprise a plurality of magnets, at least one magnet being configured to be selectively activatable. The, or each, magnet may be an electromagnet. The, or each, magnet may be a permanent magnet. The apparatus may comprise one or more electromagnets and one or more permanent magnets. In this arrangement, the apparatus comprises at least two magnets. The apparatus may comprise two or more electromagnets. The apparatus may comprise three or more electromagnets. The apparatus may comprise any number of electromagnets suitable to provide the required magnetic field to provide the required force to the vehicle. The apparatus may comprise two or more permanent magnets. The apparatus may comprise three or more permanent magnets. The apparatus may comprise any suitable number of permanent magnets to provide the required magnetic field to provide the required force to the vehicle. The apparatus may comprise two or more electromagnets and two or more permanent magnets. The apparatus may comprise three or more electromagnets and three or more permanent magnets. The apparatus may comprise any suitable number of electromagnets and permanent magnets.

The, or each, magnet may be a neodymium magnet, a Bitter electromagnet, a superconducting magnet, a ceramic magnet, or a superconducting ceramic magnet. The, or each, magnet may be any element that is capable of providing a magnetic field.

The, or each, electromagnet may include a plurality of concentrated windings. The windings may be made from metal. The metal may be copper. The, or each, electromagnet may include distributed windings, or any suitable winding configuration.

The apparatus may comprise a single electromagnet. The, or each, magnet may be a Bitter electromagnet. The apparatus may comprise a single Bitter electromagnet. The Bitter electromagnet may comprise a base. The base may be arranged in the x-z plane. The base may be arranged to be coplanar with the plane of rotation of a wheel of the vehicle.

The, or each, Bitter electromagnet may be integrally formed with a wheel of the vehicle.

The, or each, Bitter electromagnet may comprise one or more metals. The metal may be copper.

The apparatus may comprise one electromagnet for every permanent magnet. In this arrangement, the apparatus comprises an equal number of electromagnets and permanent magnets.

The, or each magnet may be a discrete magnetic component. The, or each, magnet may share at least one component, such as a magnetic core, with another magnet.

The control system may comprise one or more sensors configured to detect one or more low-adhesion events. That is, when the traction of a wheel of the vehicle is below a threshold value. The sensor(s) may be electronic sensors. The sensor(s) may be operable to provide an alert when the low-adhesion event occurs. The sensor(s) may be configured to alert a user of the vehicle, optionally the driver thereof, of the low-adhesion event. The sensor(s) may be configured to alert a user of the vehicle and to prompt the user to activate the apparatus. The control system may be configured to automatically activate the apparatus in response to received data from the sensor(s). The control system may be configured to automatically deactivate the apparatus in response to received data from the sensor(s) indicating that the low-adhesion event is no longer present. The sensor(s) may be at least one of: a revolution counter device, a tachometer, a rev counter device, an RPM counter device, and a wheel encoder, or the like.

The one or more sensors may be configured to detect one or more properties associated with the track. The one or more properties of the track may include cracks, deformities, material properties, imperfections in the track, the degree of wear on the track relative to a baseline or threshold value, or any suitable property of the track. The one or more sensors may be configured as track condition monitoring sensors.

The one or more sensors may be configured to detect one or more properties associated with the vehicle, or one or more wheels thereof. The one or more properties associated with the vehicle or wheel(s) may include cracks, deformities, material properties, imperfections on the vehicle or wheel(s), the degree of wear on the wheel(s) relative to a baseline or threshold value, or any suitable property of the vehicle or one or more wheel thereof. The one or more sensors may be configured as vehicle or wheel condition monitoring sensors.

The one or more sensors may be configured as low-adhesion event monitoring sensors, track condition monitoring sensors and/or vehicle or wheel condition monitoring sensors.

The apparatus may be connectable to one or more sources of electrical power. The source of electrical power may be an alternating current (a.c.) power supply and/or a direct current (d.c.) power supply. The source of electrical power may include a single phase power supply. The source of electrical power may include a two phase power supply. The source of electrical power may include a three phase power supply. The source of electrical power may include a four phase power supply. The source of electrical power may include a polyphase power supply. The two phase power supply may include phase A and phase B supply lines. The three phase power supply may include phase A, phase B and phase C supply lines. The four phase power supply may include phase A, phase B, Phase C and Phase D supply lines. The phases of the two phase power supply may be offset by 90 degrees, or 120 degrees. The phases of the three phase power supply may be offset by 120 degrees. The phases of the four phase power supply may be offset by 90 degrees. The electrical power source may be arranged as a star supply. The electrical power source may be arranged as a delta supply. The source of electrical power may be obtained from an on-board vehicle power supply. The source of electrical power may be obtained from one or more generator systems. The generator system(s) may be arranged on-board the vehicle. The source of electrical power may be obtained from one or more track-based, or track-side, electrical power supply systems. The source of electrical power may include one or more energy storage elements. The energy storage element(s) may include one or more batteries.

The control system may comprise one or more power management modules configured to manage the electrical power from the source of electrical power and provide suitable electrical power to the, or each, magnet. The power management module may comprise a power conversion device operable to convert d.c. electrical power to a.c. electrical power, or vice versa. The power conversion device may include an inverter, a power inverter, a rectifier, or the like.

The control system may be operable to provide electrical power to the, or each, magnet. The control system may be operable to provide electrical power to at least one of the one or more magnets. The control system may be operable to provide electrical power to the, or each magnet when in the, or each, activation zone.

The control system may comprise an electrical power module configured to provide the electrical power to the, or each magnet. The control system may comprise an electrical power module configured to provide the electrical power to at least one of the one or more magnets. The electrical power module may be configured to provide the electrical power to the, or each magnet when in the, or each activation zone.

The electrical power module may be mountable to the vehicle. The electrical power module may be fixedly attachable to the vehicle. The electrical power module may be locatable adjacent to the magnets of the apparatus. The electrical power module may be locatable adjacent to the frame member of the apparatus. The electrical power module may be located in, at, or on, a wheel of the vehicle. The electrical power module may include a vehicle mounting portion for mounting the electrical power module to the vehicle. The electrical power module may be a substantially disc shaped member.

The electrical power module may be arranged to be stationary relative to the vehicle when mounted thereto. The apparatus may be configured such that the magnets rotate relative to the electrical power module.

The control system may comprise one or more selection devices operable to selectively provide electrical power to at least one of the one or more magnets. The selection device may comprise one or more slip rings. The, or each, slip ring may be configured to selectively provide electrical power to at least one magnet. The selection device may comprise one or more wireless power transfer links. The, or each, wireless power transfer link may be configured to selectively provide electrical power to at least one magnet. The selection device may be configured to selectively provide electrical power from the electrical power module to at least one of the one or more magnets.

The selection device may be configured to define the location of the activation zone(s). The selection device may be configured to define the location of the deactivation zone(s). The selection device may be configured to define the location of the activation zone(s) and the location of the deactivation zone(s). The, or each, slip ring may define the location of the activation zone(s) and the location of the deactivation zone(s). The, or each, wireless power transfer link may be operable to define the location of the activation zone(s) and the location of the deactivation zone(s).

The selection device may comprise one or more electrical connection points connected to at least one of the magnets. The selection device may comprise one or more electrical connection points connected to the electrical power module. The selection device may be operable to selectively connect and disconnect the at least one magnet to or from the electrical power module. The selection device may be operable to selectively connect and disconnect the at least one magnet to or from the electrical power module via the electrical connection points of the selection device.

The selection device may be arranged such that, as the magnets rotate, the electrical connection points of the magnet connect with, and disconnect from, the electrical connection points of the electrical power module. The selection device may be arranged to connect the electrical connection points of the, or each, magnet to the electrical connection points of the electrical power module when the, or each, magnet is in the activation zone(s). The selection device may be arranged to disconnect the electrical connection points of the electrical power module and the, or each, magnet, when the, or each, magnet is in the deactivation zone(s).

The apparatus may be operable to change the location of at least one of the activation zone(s). The apparatus may be operable to change the location of at least one of the deactivation zone(s). The apparatus may be operable to change the location of the activation zone(s) and the location of the deactivation zone(s). The control system may be operable to activate or deactivate one or more of the electrical connection points of the electrical power module. In this arrangement, the control system can determine the location of the activation and deactivation zone(s), which can be adjusted, optionally during use of the apparatus.

The electrical connection points of the, or each, magnet may each include one or more first electrodes and one or more second electrodes. The first electrode may be the signal electrode and the second electrode may be a common, or return, electrode. The second electrode may be common to two or more of the magnets. The second electrode may be common to all of the magnets.

The electrical connection points of the electrical power module may each include a first electrode and a second electrode. The first electrode may be the signal electrode and the second electrode may be a common, or return, electrode. The second electrode may be common to all electrical connection points of the electrical power module.

The slip ring may be configured to selectively connect the first electrodes of the, or each, magnet to the first electrodes of the electrical power module. The slip ring may be configured to selectively connect the second electrodes of the, or each, magnet to the second electrodes of the electrical power module. The wireless power transfer link may be operable to selectively transfer power from the first electrodes of the, or each, magnet to the first electrodes of the electrical power module. The wireless power transfer link may be operable to selectively transfer power from the second electrodes of the, or each, magnet to the second electrodes of the electrical power module.

The second electrode(s) of the magnets and the second electrode(s) of the electrical power module may be arranged to always be in electrical communication with each other. The slip ring may be configured to connect the common electrode of the magnets and the common electrode of the electrical power module together. The wireless power transfer link may be operable to electrically connect the common electrode of the magnets and the common electrode of the electrical power module.

The cross-sectional contact area of the signal electrodes of the magnets may be arranged to be smaller than the cross-sectional contact area of the signal electrodes of the electrical power module. The cross-sectional contact area of the signal electrodes of the magnets may be arranged to be larger than the cross-sectional contact area of the signal electrodes of the electrical power module.

The electrical connection points of the magnets may be located on a first surface of the frame member. The first surface may be a planar surface.

The electrical connection points of the electrical power module may be located on a first surface thereof. The first surface may be a planar surface. The first surface of the frame member and the first surface of the electrical power module may be arranged to be opposed surfaces. The first surfaces may be arranged to be adjacent to each other.

The first and/or second electrodes of the magnets may be arranged at least partially in a circular arrangement, or an elliptical arrangement. The first and/or second electrodes of the magnets may be arranged radially with respect to the plane of rotation of the magnets. The first and/or second electrodes of the electrical power module may be arranged at least partially in a circular arrangement or an elliptical arrangement. The first and/or second electrodes of the electrical power module may be arranged radially with respect to the plane of rotation of the magnets.

The, or each activation zone may be associated with one or more phase lines of the power supply. The, or each activation zone may be associated with a single phase of the power supply. The control system may be configured to apply a first phase to the, or each, magnet when located in the first activation zone. The apparatus may be configured to apply a second phase to the, or each, magnet when located in the second activation zone. The apparatus may be configured to apply a third phase to the, or each magnet when located in the third activation zone. The first phase may be phase A, phase B, or phase C. The second phase may be phase A, phase B or Phase C. The third phase may be phase A, phase B or phase C. The first phase may be phase A, the second phase may be phase B and the third phase may be phase C.

The apparatus may comprise a fourth activation zone and a fourth deactivation zone. The fourth activation zone may be located adjacent to the third deactivation zone. The fourth deactivation zone may be located adjacent to the fourth activation zone and adjacent to the first activation zone. The apparatus may be configured to apply a fourth phase to the, or each, magnet when located in the fourth activation zone. The first phase may be phase A, phase B, phase C, or phase D. The second phase may be phase A, phase B, phase C, or phase D. The third phase may be phase A, phase B, phase C, or phase D. The fourth phase may be phase A, phase B, phase C, or phase D.

The control system may be operable to apply a first phase to a first magnet. The control system may be operable to apply a second phase to a second magnet. The control system may be operable to apply a third phase to a third magnet. The control system may be operable to apply a fourth phase to a fourth magnet.

The magnets may be distributed in a sequence of first and second magnets. The magnets may be distributed in a sequence of first, second and third magnets. The magnets may be distributed in a sequence of first, second, third and fourth magnets. The magnets may be radially distributed in the x-z plane.

The first phase and second phase may be offset by 120 degrees. The second phase and third phase may be offset by 120 degrees. The third and the first phase may be offset by 120 degrees.

The first phase and second phase may be offset by 90 degrees. The second and third phase may be offset by 90 degrees. The third and the fourth phase may be offset by 90 degrees. The fourth and the first phase may be offset by 90 degrees.

The control system may be operable to connect each magnet to any one of the phases of the electrical power supply.

The control system may be configured to switch each magnet from a first phase of electrical power supply to a second phase of electrical power supply. The control system may be configured to switch each magnet from a second phase of electrical power supply to a third phase of electrical power supply. The control system may be configured to switch each magnet from a third phase of electrical power supply to a first phase of electrical power supply. The control system may be configured to switch each magnet from a third phase of electrical power supply to a fourth phase of electrical power supply.

The apparatus may be configured to apply the same electrical phase to each magnet (single phase mode). The magnets may be arranged in a single phase arrangement, a two phase arrangement, a three phase arrangement, a polyphase arrangement, and/or a four phase arrangement.

The apparatus may be configured such that the, or each, magnet has no predetermined electrical phase. In this arrangement, the, or each magnet may be connected to any electrical phase line during the operation of the apparatus.

The apparatus may be configured to connect the magnets in a three phase star connection when the magnets are located in the activation zones. In this arrangement, one or more magnets are connected to phase A and the common line, one or more magnets are connected to phase B and the common line, and one or more magnets are connected to phase C and the common line. The magnets may be arranged in a three phase delta connection when the magnets are located in the activation zones. In this arrangement, one or more magnets are connected to phase A and phase B, one or more magnets are connected to phase B and phase C, and one or more magnets are connected to phase C and phase A. The electrical power supply to the magnets, and the magnets, may be arranged in a star-star configuration, or a star-delta configuration, or a delta-delta configuration, or a delta-star configuration.

At least one magnet may be configured to provide a static magnetic field. A plurality of magnets may be configured to provide a static magnetic field. All of the magnets may be configured to provide a static magnetic field.

The apparatus may be configured to apply a magnetic field from the one or more magnets radially at least partially in the x-z plane. The apparatus may be configured to apply a magnetic field from the one or more magnets substantially towards the track. The apparatus may be configured to direct the magnetic field towards the track. The magnets may be arranged to provide a magnetic field component that is substantially along the y-axis of the vehicle. The magnets may be arranged to provide a magnetic field component that is substantially along the z-axis of the vehicle. The magnets may be arranged to provide a magnetic field component that is substantially along the x-axis of the vehicle. The magnets may be arranged to provide a magnetic field component that is substantially along the x-axis, the y-axis, and/or the z-axis of the vehicle.

The magnets may be arranged to provide a magnetic field component that is perpendicular to the direction of travel of the vehicle. The magnets may be arranged to provide a magnetic field component that is aligned to the direction of travel of the vehicle. The magnets may be arranged to provide a magnetic field component that is directed towards the contact point of the wheel of the vehicle with the track.

The magnets may be rotationally offset from each other. The magnets may be rotationally offset in the x-z plane. The magnets may be rotationally offset about the axis of rotation of the magnets. The magnets may be arranged with one pole proximal to the axis of rotation and one pole distal to the axis of rotation.

The, or each, magnet may be arranged to provide a higher magnetic flux density towards the track. The, or each, magnet, may be arranged to provide a higher magnetic flux density towards the track when the, or each, magnet is in the activation zone(s). The, or each, magnet may be arranged to focus the magnetic field towards the track. The magnets may be arranged to focus the magnetic field towards the track and complete a magnetic circuit between the magnets and at least a portion of the track. The magnets may be arranged to focus the magnetic field towards the track and complete a magnetic circuit between a wheel of the vehicle and at least a portion of the track.

The apparatus may comprise one or more magnetic guide elements configured to guide, or direct, or focus the magnetic field from the, or each, magnet towards the track. The, or each, magnet may comprise at least one magnetic guide element. The, or each, magnetic guide element may be made from a metal material, a ferrous material, an alloy material, ferromagnetic steel, carbon, steel, carbon steel, and/or 1080 carbon steel.

The apparatus may comprise one or more magnetic shield elements. The, or each, magnet shield element may be arranged to reduce the magnetic coupling between two or more magnets. The, or each, magnetic shield element may be arranged to reduce the magnetic coupling between two or more magnetic guide elements. The magnetic shield elements may be made from a metal material, a material with a low magnetic permeability, a non-ferrous material, a stainless steel material, and/or 304 stainless steel.

The, or each, magnetic guide element may be located adjacent to one or more magnetic shield elements.

The, or each, magnetic guide element may be arranged such that at least a portion thereof is adjacent to at least a portion of the track. The, or each, magnetic guide element may be arranged such that at least a portion thereof is in contact with at least a portion of the track. The, or each, magnetic shield element may be arranged such that at least a portion thereof is adjacent to at least a portion of the track. The, or each, magnetic shield element may be arranged such that at least a portion thereof is in contact with at least a portion of the track.

The, or each, magnetic guide element may be configured to be fixed relative to the, or each, magnet. In this arrangement, the magnetic guide element(s) rotate with the magnet(s). The, or each, magnetic shield element may be configured to be fixed relative to the, or each, magnet. In this arrangement, the magnetic shield element(s) rotate with the magnet(s).

Two or more magnets may share a common magnetic guide element. Two or more magnets may share a common magnetic shield element.

The magnetic guide elements may be spaced apart from another magnetic guide element. The magnetic guide elements may be spaced apart along the y-axis of the vehicle. The magnetic guide elements may be spaced apart radially in the x-z plane.

The magnetic guide elements may be arranged such that at least a portion of each magnetic guide element is spaced apart from at least a portion of another magnetic guide element. The magnetic guide elements may be spaced apart along the y-axis of the vehicle. The magnetic guide elements may be spaced apart radially in the x-z plane.

One or more of the magnets may be arranged at a first radius from the axis of rotation. One or more of the magnets may be arranged at a second radius from the axis of rotation. The magnet(s) of the first radius may be associated with one or more first magnetic guide members. At least a part of each first magnetic guide member may be arranged between two or more of the magnets of the second radius.

The magnetic guide members may include one or more elongate members.

At least a part of the magnetic guide members may form part of the structure of a wheel of the vehicle. At least a part of the magnetic guide members may be configured to run on the track. At least a part of the magnetic guide members may form at least a part of a tread portion of a wheel of the vehicle. At least a part of the magnetic guide members may form at least a part of a flange portion of a wheel of the vehicle.

The, or each, magnetic guide element may include one or more magnetic cores. The apparatus may include a plurality of magnets, and at least one of the magnets may include a magnetic guide element. The, or each, magnetic guide element may be made from a material with a high magnetic permeability, one or more ferrous materials, a metal material, iron, steel, electrical steel, ceramics, and/or a material configured to have a high magnetic permeability at superconducting temperatures, or the like. The, or each, magnetic guide element may be arranged to focus more of the magnet's magnetic field towards the track. Two or more magnets may be arranged to share a common magnetic guide element. All of the magnets may be arranged to share one or more common magnetic guide elements.

The apparatus may include one or more magnets arranged in a Halbach array.

Each magnet may be spaced apart from the next magnet. The magnets may be evenly distributed. The magnets may be evenly distributed on the frame member. Each magnet may be adjacent to another magnet.

The magnets may be arranged such that at least one pole of each magnet is adjacent to at least one pole of another magnet. The magnets may be arranged such that a first pole of each magnet is adjacent to a first pole of another magnet, and a second pole of each magnet is located adjacent to a second pole of another magnet. The distance between the first poles of each adjacent magnet may be less than the distance between the second poles of each adjacent magnet.

The magnets may be arranged such that one magnetic pole is proximal to the track and another magnetic pole is distal to the track, when the magnet is located in close proximity to the track. The magnets may be arranged such that two or more magnetic poles thereof are adjacent to the track when the magnet is located in close proximity to the track.

The control system may be operable to move the magnets between a first position and a second position. In the first position, a first pole of the magnet may be closer to the track than the second pole. In the second position, the second pole of the magnet may be closer to the track than the first pole. The control system may be operable to rotate the magnets at least partially about an axis of rotation. In this arrangement, the location of the poles of the magnet relative to the track can be adjusted.

The frame member may be a rotor. The frame member may be formed by one or more substrates. The apparatus may be a modular apparatus formed from two or more substantially identical components. The frame member may be a modular frame member formed from two or more substantially identical components. The frame member may be configured to accommodate the magnets therein. The frame member may be a housing for the magnets. The frame member may be substantially disc shaped, or wheel shaped.

The frame member may be integrally formed with the vehicle. The frame member may be mountable to the vehicle. The frame member may be integrally formed with a wheel of the vehicle. The frame member may be mountable to a wheel of the vehicle. The magnets may be fixedly attachable to a wheel of the vehicle. The frame member may be located on a wheel of the vehicle. The frame member may be located at a wheel of the vehicle. The frame member may be connectable to the vehicle, or a wheel thereof. The frame member may be located substantially adjacent to a wheel of the vehicle. The frame member may be arranged to be spaced apart from a wheel of the vehicle. The frame member may be arranged to be spaced apart from the wheels of the vehicle. The frame member may be arranged to be in contact with the track when the vehicle is located thereon. The frame member may be arranged to be spaced from the track when the vehicle is located thereon. The frame member may be arranged to be spaced from the track when the vehicle is levitated relative to the track. The frame member may be configured to rotate relative to a wheel of the vehicle. The frame member may be configured to rotate at a different speed to a wheel of the vehicle.

The magnets may be configured to be rotatable about at least one axis of rotation. The magnets may be configured to be rotatable about a single axis of rotation. The axis of rotation may be the x-axis of the vehicle. The axis of rotation may be substantially in the same direction as the direction of motion of the vehicle. The axis of rotation may be the y-axis of the vehicle. The axis of rotation may be perpendicular to the direction of motion of the vehicle. The axis of rotation may be the z-axis of the vehicle. The axis of rotation may be arranged vertically with respect to the vehicle.

The frame member may be mountable to a corresponding frame member receiving apparatus of the vehicle. The frame member may be configured to be rotatable at least partially about the at least one of axis of rotation when mounted to the frame member receiving apparatus of the vehicle.

The frame member receiving apparatus may be an axle, a rod member, a pole, a bar, or the like. The frame member receiving apparatus may be configured to rotate the frame member. The frame member receiving apparatus may be configured to rotate the frame member and to not rotate the electrical power module.

The frame member may include one or more engagement portions. The engagement portion(s) may be configured to engage with the vehicle. The engagement portion(s) may be configured to engage with the frame member receiving apparatus of the vehicle. The engagement portion may be a hole, aperture, through bore, opening, or the like in the frame member.

The frame member may be mountable to one or more frame member receiving apparatus of the vehicle. In this arrangement, a plurality of apparatuses could be mounted to the vehicle.

The vehicle may comprise a motor operable to rotate the magnets when rotatably mounted to the vehicle. The motor may be operable to rotate a wheel of the vehicle and the magnets of the apparatus.

The frame member receiving apparatus of the vehicle may include a wheel receiving apparatus for receiving a wheel of the vehicle.

The magnet(s) may be configured to be rotatable entirely about the at least one axis of rotation. The magnet(s) may be configured to be rotatable about a single axis of rotation when mounted to the vehicle. The magnet(s) may be configured to be fully rotatable about the single axis of rotation.

The axis of rotation of the magnet(s) may be substantially parallel to an axis of rotation of a wheel of the vehicle. The axis of rotation of the magnet(s) and the axis of rotation of a wheel of the vehicle may be coaxial. The magnet(s) may be configured to rotate synchronously with a wheel of the vehicle when the magnet(s) are mounted to the vehicle. In this arrangement, the magnet(s) rotate at the same rate as the wheel. The magnet(s) may be configured to rotate asynchronously with a wheel of the vehicle when the magnet(s) are mounted to the vehicle. In this arrangement, the magnet(s) rotate at a different speed to the wheel of the vehicle.

The axis of rotation of the magnet(s) may be offset with respect to the axis of rotation of the wheel of the vehicle. The offset may be along the x-axis of the vehicle. The offset may be along the y-axis of the vehicle. The offset may be along the z-axis of the vehicle. The offset may be along the x-axis, the y-axis and/or the z-axis of the vehicle.

The magnet(s) may be arranged to rotate in the same plane as a wheel of the vehicle.

The magnet(s) may be arranged to rotate in a circular path, or elliptical path.

The, or each, magnet may be at least partially pivotably mountable with respect to at least a part of the vehicle. In this arrangement, the magnet(s) are partially pivotable about the axis of rotation, or are fully pivotable or rotatable about the axis of rotation.

The, or each, magnet may be pivotable about an axis of rotation from a first position to a second position. The first position and the second position are the same position in embodiments where the magnets are fully rotatable about the axis of rotation.

The rotation of the magnets may be in the clockwise direction. The rotation of the magnets may be in the anti-clockwise direction. The control system may be operable to rotate the magnet(s) in a clockwise and/or anti-clockwise direction. The rotation of the magnet(s) may be in the same direction as the rotation of a wheel of the vehicle. The rotation of the magnet(s) may be in the opposite direction as the rotation of a wheel of the vehicle.

The frame member may comprise one or more magnet receiving portions. The magnetic receiving portions may be configured to receive one or more components of the magnet(s).

The apparatus may be a rugged apparatus. The apparatus may be configured to be vibration-resistant. The frame member may be a rigid member. The apparatus may be retrofittable to a vehicle. The apparatus may be retrofittable to a wheel of the vehicle. The apparatus may form part of the structure of a wheel of the vehicle.

The apparatus may comprise one or more temperature control modules. The temperature control module may include a cooling module. The cooling module may be an air cooling module. The cooling module may comprise one or more fluid flow devices. The fluid flow device may be a fan, a blower, or the like. The cooling module may comprise one or more liquid cooling modules. The liquid cooling module may include a rotary union element. The temperature control module may comprise one or more heat transfer elements. The heat transfer element may be configured to transfer heat away from at least a part of the apparatus and/or a wheel of the vehicle. The heat transfer element may be a heat sink, or the like. The temperature control module may be operable to at least partially control the temperature of at least a portion of the apparatus and/or a wheel of the vehicle.

The apparatus may comprise a traction assistance device operable to increase the traction of a wheel of the vehicle to the track. The traction assistance device may be operable to apply a traction agent to at least a portion of the wheel of the vehicle. The traction assistance device may be operable to apply the traction agent to a tread portion and/or a flange portion of the wheel of the vehicle. The traction assistance device may be operable to apply the traction agent to at least a portion of the wheel that is, in use, in contact with the track. The traction assistance device may be operable to apply the traction agent to at least a portion of the track. The traction assistance device may be operable to apply the traction agent directly to at least a portion of the track.

The traction assistance device may be arranged to be spaced apart from the wheel of the vehicle. The traction assistance device may be arranged to be spaced apart from the wheel along the z-axis of the vehicle. The traction assistance device may be located adjacent to the wheel of the vehicle. The traction assistance device may be located adjacent to the wheel of the vehicle. The traction assistance device may be fixedly attached to the vehicle, such that, in use, the wheel of the vehicle moves relative to the traction assistance device. The traction assistance device may be located at least partially within the wheel of the vehicle. The traction assistance device may be located at least partially on the wheel, at least partially within the wheel, and/or substantially adjacent to the wheel. In some examples, the traction assistance device may be located within the wheel, such that the traction agent is effectively provided from the wheel itself to the track.

The, or each, magnet of the apparatus may be operable to attract the traction agent to the wheel of the vehicle. The magnets of the apparatus may be operable to adhere the traction agent to the wheel of the vehicle.

The traction agent may be configured to increase the contact friction of the wheel of the vehicle to the track, when the traction agent is located on the wheel of the vehicle. The traction agent may be configured to increase the surface area of at least one surface of the wheel of the vehicle when located thereon. The traction agent may be configured to increase the surface roughness of at least one surface of the wheel of the vehicle when located thereon.

The traction agent may include one or more fluids. The fluid may include one or more solids, liquids and/or gases. The fluid may include one or more metals and/or ferrous metals. The traction agent may be configured to increase the magnetic coupling between the wheel of the vehicle and the track when the traction agent is located on the wheel.

The traction assistance device may be connectable to a source of the traction agent.

The traction assistance device may be operable to remove the traction agent from at least a portion of the wheel of the vehicle. The traction assistance device may be operable to remove the traction agent from a tread portion and/or a flange portion of the wheel of the vehicle.

The traction assistance device may comprise one or more fluid transfer devices operable to apply and/or remove the traction agent to or from the wheel of the vehicle. The fluid transfer device(s) may include one or more nozzles, orifices, holes, or the like, for dispensing and/or collecting the traction agent.

The traction assistance device may comprise one or more magnets operable to apply and/or remove the traction agent to or from the wheel of the vehicle. The magnets may be configured to be selectively activatable. The magnets may include one or more electromagnets. The magnets may be operable to attract the traction agent from the source of the traction agent towards the magnet. The magnets may be operable to repel the traction agent away from the magnet and towards the wheel of the vehicle.

The magnets of the apparatus may be operable to repel the traction agent from the wheel of the vehicle. For example, when the traction agent is no longer required, such as at high speed, the traction agent can be removed by the magnets.

The apparatus may comprise a single traction assistance device. The apparatus may comprise a plurality of traction assistance devices. Each traction assistance device may be operable to apply and/or remove the traction agent to or from the wheel of the vehicle. In this arrangement, the apparatus could comprise separate traction assistance devices for applying and removing the traction agent.

The traction assistance device may comprise a body portion. The body portion may include one or more concave faces, arcuate faces, curved faces, and/or planar faces, arranged opposite the wheel of the vehicle, or a tread portion thereof.

The apparatus may be operable to store data associated with the operation of the apparatus. The apparatus may comprise one or more data storage devices for storing data associated with the operation of the apparatus.

The apparatus may be operable to transmit data associated with the operation of the apparatus to a computing device, a networked computing device, a communications network, or the like. The apparatus may comprise one or more communication elements for transmitting the data associated with the operation of the apparatus.

The apparatus may be operable to receive data from one or more sensor devices. The one or more sensor devices may be locatable on the vehicle. The one or more sensor devices may be configured to detect at least one property of the vehicle, one or more wheels thereof, and/or the track. The apparatus may be operable to send and receive data to and from the one or more sensor devices. The apparatus may be configured to communicate with the one or more sensor devices wirelessly. The one or more sensor devices may be internet-of-things devices, or the like. The apparatus may comprise a sensor device communication element for sending and/or receiving data to or from the, or each sensor device.

According to a second aspect of the present invention there is provided an apparatus for applying a force to a structure, the apparatus comprising:
one or more magnets, the one or more magnets being rotatably mountable with respect to at least part of a structure,
wherein the structure is locatable on or adjacent to an object, the object comprising one or more electrically conductive portions,
wherein the magnets are configured such that their rotation relative to the object induces one or more electrical currents in the object, the, or each electrical current creating a magnetic field, such that a force is applied to the structure.

The apparatus may be locatable on, or adjacent to, a plurality of objects. The structure may be a vehicle, or a part thereof. The structure may be a stationary, or movable, structure. The structure may be any suitable structure to which the magnets can be rotatably mountable.

The object may be a track. The object may be a stationary object. The object may be a movable object. The object may be locatable on the ground. The object may be configured to be securable to the ground, or to another structure.

The structure may be configured to run on, or adjacent to, the object. The structure may be configured to run on a portion of the object and run adjacent to another portion of the object.

The structure may be a robot. The structure may be a robotic vehicle. The object may include an inclined portion.

The structure may be an automotive vehicle. The object may form part of a road surface. The road surface may include one or more electrically conductive portions. The road surface may include one or more metals, or one or more ferrous metals.

The structure may comprise one or more wheels.

The object may comprise one or more metallic portions. The object may be a metallic object. At least a portion of the object may comprise one or more ferrous materials, one or more metals, or an alloy material. The metals may be ferrous metals. The metals may be iron and/or steel, or the like.

The apparatus may be operable to apply magnetic friction between the structure and the object. The apparatus may be operable to increase the magnetic friction between the structure and the object.

The apparatus may be operable to increase the traction of the structure to the object. In this arrangement, the structure may be in contact with the object, or it may be suspended relative to the object or levitated above the object, and the apparatus is operable to increase the traction of the structure.

The apparatus may be operable to increase the contact friction between one or more surfaces of the structure and the object. The surface(s) may be located on one or more wheels of the structure.

The apparatus may be operable to increase the adhesion, or grip, of the structure to a surface, such as the surface of the object.

The apparatus may be operable to provide an attractive force between the structure and the object, in accordance with Coulomb's law. The apparatus may be operable to provide a repulsive force between the structure and the object, in accordance with Coulomb's law. The apparatus may be operable to provide an attractive and/or repulsive force between the structure and the object. The apparatus may be operable to exert a drag force on the structure.

The magnets may be configured such that their rotation relative to the object induces one or more electrical eddy currents in the object. The one or more electrically conductive portions of the object may be arranged such that rotation of the magnets relative thereto induces one or more electrical eddy currents therein. The one or more electrically conductive portions may be arranged to promote the formation of electrical eddy currents in response to the magnets rotating relative thereto. The electrically conductive portion(s) of the object may include one or more planar surfaces. The electrically conductive portion(s) of the object may include an upper surface located adjacent to the structure. The upper surface may be a planar surface.

The magnets are configured such that their rotation relative to the object induces one or more electrical currents in the object, in accordance with Faraday's law of induction. The one or more electrical currents in the object create a magnetic field, in accordance with Ampere's circuital law such that a magnetic field is applied to the structure. The direction of the induced electrical current and thus the direction of the magnetic field produced by the induced current is determined by Lenz's law. Thus, rotation of the magnets relative to the object applies a force to the structure. It will be understood that depending on the properties of the magnet, or magnets, the rate of rotation, the direction of rotation, and the properties of the structure, apparatus and object, that the direction and magnitude of the force can be variable and can be configured in a number of ways. In this arrangement, the operation of the apparatus results in magnetic friction or magnetic attraction between the structure and the object.

The apparatus may be operable, in use, to apply a variable, or alternating, magnetic field to the object, which induces a variable, or alternating electrical current in the object, which in turn provides a variable, or alternating magnetic field to the structure in accordance with Faraday's law of induction, Ampere's circuital law and Lenz's law. In this arrangement, applying a variable or alternating magnetic field to the object can result in magnetic friction or magnetic attraction. It will be appreciated that the variable or alternating magnetic field can be provided by the apparatus by moving the magnets and/or by varying the magnetic properties thereof (e.g. by varying the magnetic field intensity and/or magnetic polarity).

The apparatus may be configured to apply a variable magnetic field to the object.

The structure may comprise an x-axis, a y-axis and a z-axis. The structure may move relative to the object substantially in the direction of the x-axis of the structure. The structure may be configured to move relative to the object substantially in the direction of the x-axis and/or the y-axis. The structure may be configured to move relative to the object in the direction of the z-axis. The structure may be configured to move relative to the object substantially in the direction of the x-axis, y-axis, and/or the z-axis. The z-axis may be a vertical axis of the structure. The structure may be operable to fly, hover, or levitate above the object in the direction of the z-axis. The length of the structure may be along the x-axis. The width of the structure may be along the y-axis. The height of the structure may be along the z-axis.

The wheel(s) of the structure may be configured to rotate about the y-axis of the structure. The wheel of the structure may have a plane of rotation. The plane of rotation of the wheel of the structure may be an x-z plane of the structure.

The axis of rotation of the magnet(s) may be the y-axis of the structure. The plane of rotation of the magnet(s) may be an x-z plane of the structure. The plane of rotation of the magnets may be an x-y plane of the structure. The plane of rotation of the magnets may be a y-z plane of the structure. The plane of rotation of the magnet(s) may be substantially co-planar with the plane of rotation of a wheel of the structure. The control system may be mountable to the structure. The control system may be located on the structure.

The control element may be located on, or inside, the structure. The control element may be arranged to be accessible by a user of the structure, optionally an operative, or driver, thereof.

The apparatus may comprise one or more activation zones located at a lower region of the structure. The apparatus may comprise one or more activation zones located at a lower region of a wheel of the structure. The apparatus may comprise one or more activation zones located at a region of the structure that is adjacent to at least a portion of the object.

The apparatus may comprise one or more deactivation zones located at an upper region of a wheel of the structure.

The apparatus may comprise one or more activation zones located proximal to the object and one or more deactivation zones located distal to the object. The apparatus may comprise one or more activation zones located proximal to the object, one or more deactivation zones located proximal to the object and one or more deactivation zones located distal to the object. At least a part of the activation zone(s) may be located adjacent to the object. At least a part of a deactivation zone(s) may be located adjacent to the object.

The source of electrical power may be obtained from an on-board power supply of the structure. The source of electrical power may be obtained from one or more generator systems. The generator system(s) may be arranged on-board the structure. The source of electrical power may be obtained from one or more object-based, or object-side, electrical power supply systems.

The apparatus may be configured to apply a magnetic field from the one or more magnets radially at least partially in the x-z plane. The apparatus may be configured to apply a magnetic field from the one or more magnets substantially towards the object. The apparatus may be configured to direct the magnetic field towards the object. The magnets may be arranged to provide a magnetic field component that is substantially along the y-axis of the structure. The magnets may be arranged to provide a magnetic field component that is substantially along the z-axis of the vehicle. The magnets may be arranged to provide a magnetic field component that is substantially along the x-axis of the structure. The magnets may be arranged to provide a magnetic field component that is substantially along the x-axis, the y-axis, and/or the z-axis of the structure.

The magnets may be arranged to provide a magnetic field component that is perpendicular to the direction of travel of the structure. The magnets may be arranged to provide a magnetic field component that is aligned to the direction of travel of the structure. The magnets may be arranged to provide a magnetic field component that is directed towards the contact point of the wheel of the structure with the object.

The, or each, magnet may be arranged to provide a higher magnetic flux density towards the object. The, or each, magnet, may be arranged to provide a higher magnetic flux density towards the object when the, or each, magnet is in the activation zone(s). The, or each, magnet may be arranged to focus the magnetic field towards the object. The magnets may be arranged to focus the magnetic field towards the object and complete a magnetic circuit between the magnets and at least a portion of the object. The magnets may be arranged to focus the magnetic field towards the object and complete a magnetic circuit between a wheel of the structure and at least a portion of the object.

The apparatus may comprise one or more magnetic guide elements configured to guide, or direct, or focus the magnetic field from the, or each, magnet towards the object.

The, or each, magnetic guide element may be arranged such that at least a portion thereof is adjacent to at least a portion of the object. The, or each, magnetic guide element may be arranged such that at least a portion thereof is in contact with at least a portion of the object. The, or each, magnetic shield element may be arranged such that at least a portion thereof is adjacent to at least a portion of the object. The, or each, magnetic shield element may be arranged such that at least a portion thereof is in contact with at least a portion of the object.

The magnetic guide elements may be spaced apart along the y-axis of the structure. The magnetic guide elements may be spaced apart radially in the x-z plane.

The magnetic guide elements may be arranged such that at least a portion of each magnetic guide element is spaced apart from at least a portion of another magnetic guide element. The magnetic guide elements may be spaced apart along the y-axis of the structure. The magnetic guide elements may be spaced apart radially in the x-z plane.

At least a part of the magnetic guide members may form part of the structure of a wheel of the structure. At least a part of the magnetic guide members may be configured to run on the object. At least a part of the magnetic guide members may form part of a tread portion of a wheel of the structure. At least a part of the magnetic guide members may form part of a flange portion of a wheel of the structure.

The magnets may be arranged such that one pole is proximal to the object and the other pole is distal to the object, when the magnet is located in close proximity to the object. The magnets may be arranged such that both poles are adjacent to the object when the magnet is located in close proximity to the object.

The control system may be operable to move the magnets between a first position and a second position. In the first position, a first pole of the magnet may be closer to the object than the second pole. In the second position, the second pole of the magnet may be closer to the object than the first pole. The control system may be operable to rotate the magnets at least partially about an axis of rotation. In this arrangement, the location of the poles of the magnet relative to the object can be moved.

The frame member may be integrally formed with the structure. The frame member may be mountable to the structure. The frame member may be integrally formed with a wheel of the structure. The frame member may be mountable to a wheel of the structure. The magnets may be fixedly attachable to a wheel of the structure. The frame member may be located on a wheel of the structure. The frame member may be located at a wheel of the structure. The frame member may be connectable to the structure, or a wheel thereof. The frame member may be located substantially adjacent to a wheel of the structure. The frame member may be arranged to be spaced apart from a wheel of the structure. The frame member may be arranged to be spaced apart from the wheels of the structure. The frame member may be arranged to be in contact with the object when the structure is located thereon. The frame member may be arranged to be spaced from the object when the structure is located thereon. The frame member may be arranged to be spaced from the object when the structure is levitated relative to the object.

The magnets may be configured to be rotatable about at least one axis of rotation. The magnets may be configured to be rotatable about a single axis of rotation. The axis of rotation may be the x-axis of the structure. The axis of rotation may be substantially in the same direction as the direction of motion of the structure. The axis of rotation may be the y-axis of the structure. The axis of rotation may be perpendicular to the direction of motion of the structure. The axis of rotation may be the z-axis of the structure. The axis of rotation may be arranged vertically with respect to the structure.

The frame member may be mountable to a corresponding frame member receiving apparatus of the structure.

The axis of rotation of the magnet(s) may be substantially parallel to an axis of rotation of a wheel of the structure. The axis of rotation of the magnet(s) and the axis of rotation of a wheel of the structure may be coaxial.

The axis of rotation of the magnet(s) may be offset with respect to the axis of rotation of the wheel of the structure. The offset may be along the x-axis of the structure. The offset may be along the y-axis of the structure. The offset may be along the z-axis of the structure. The offset may be along the x-axis, the y-axis and/or the z-axis of the structure.

The apparatus may be a rugged apparatus. The apparatus may be configured to be vibration-resistant. The frame member may be a rigid member. The apparatus may be retrofittable to a structure.

Embodiments of the second aspect of the present invention may include one or more features of the first aspect of the present invention or its embodiments. Similarly, embodiments of the first aspect of the present invention may include one or more features of the second aspect of the present invention or its embodiments.

According to a third aspect of the present invention there is provided an apparatus for applying a force to a rail vehicle on a track, the apparatus comprising:
one or more magnets, the one or more magnets being rotatably mountable with respect to at least part of the rail vehicle,
wherein the track comprises one or more electrically conductive portions; and
wherein the magnets are configured such that their rotation relative to the track induces one or more electrical currents in the track, the, or each electrical current creating a magnetic field, such that a force is applied to the rail vehicle.

The track may comprise one or more rail members. The rail vehicle may be configured to run on at least one rail member. The rail vehicle may be configured to levitate above, or adjacent to, at least one rail member.

Embodiments of the third aspect of the present invention may include one or more features of the first and/or second aspects of the present invention or their embodiments. Similarly, embodiments of the first and/or second aspects of the present invention may include one or more features of the third aspect of the present invention or its embodiments.

According to a fourth aspect of the present invention there is provided an apparatus for applying a force to a levitation vehicle on a track, the apparatus comprising:
one or more magnets, the one or more magnets being rotatably mountable with respect to at least part of the levitation vehicle,
wherein the track comprises one or more electrically conductive portions,
wherein the magnets are configured such that their rotation relative to the track induces one or more electrical currents in the track, the, or each electrical current creating a magnetic field, such that a force is applied to the levitation vehicle.

The levitation vehicle may be configured to run adjacent, or near to, the track.

Embodiments of the fourth aspect of the present invention may include one or more features of the first, second and/or third aspects of the present invention or their embodiments. Similarly, embodiments of the first, second, and/or third aspects of the present invention may include one or more features of the fourth aspect of the present invention or its embodiments.

According to a fifth aspect of the present invention there is provided an apparatus for applying a force to a vehicle on a track, the apparatus comprising:
one or more magnets being mountable with respect to at least part of the vehicle; and
wherein the track comprises one or more electrically conductive portions; and
   wherein the magnets are configured such that they induce one or more electrical currents in the track, the, or each electrical current creating a magnetic field, such that a force is applied to the vehicle.

Embodiments of the fifth aspect of the present invention may include one or more features of the first, second, third and/or fourth aspects of the present invention or their embodiments. Similarly, embodiments of the first, second, third and/or fourth aspects of the present invention may include one or more features of the fifth aspect of the present invention or its embodiments.

According to a sixth aspect of the present invention there is provided an apparatus for applying a force to a structure, the apparatus comprising: one or more magnets being mountable with respect to at least part of the structure; and
wherein the structure is locatable on or adjacent to an object, the object comprising one or more electrically conductive portions; and
   wherein the magnets are configured such that they induce one or more electrical currents in the object, the, or each electrical current creating a magnetic field, such that a force is applied to the structure.

Embodiments of the sixth aspect of the present invention may include one or more features of the first, second, third, fourth and/or fifth aspects of the present invention or their embodiments. Similarly, embodiments of the first, second, third, fourth and/or fifth aspects of the present invention may include one or more features of the sixth aspect of the present invention or its embodiments.

According to a seventh aspect of the present invention there is provided a method of applying a force to a vehicle, the method comprising the steps of:
providing an apparatus for applying a force to a vehicle on a track, the apparatus comprising:
   one or more magnets, the one or more magnets being rotatably mountable with respect to at least part of the vehicle,
   wherein the track comprises one or more electrically conductive portions;
   wherein the magnets are configured such that their rotation relative to the track induces one or more electrical currents in the track, the, or each electrical current creating a magnetic field, such that a force is applied to the vehicle; and
rotatably mounting the one or more magnets with respect to at least part of the vehicle; and
using the apparatus to rotate the one or more magnets with respect to at least a part of the vehicle.

Embodiments of the seventh aspect of the present invention may include one or more features of the first, second, third, fourth, fifth and/or sixth aspects of the present invention or their embodiments. Similarly, embodiments of the first, second, third, fourth, fifth and/or sixth aspects of the present invention may include one or more features of the seventh aspect of the present invention or its embodiments.

According to an eighth aspect of the present invention there is provided a method of applying a force to a structure, the method comprising the steps of:
providing: an apparatus for applying a force to a structure, the apparatus comprising:
   one or more magnets, the one or more magnets being rotatably mountable with respect to at least part of the structure,
   wherein the structure is locatable on or adjacent to an object, the object comprising one or more electrically conductive portions;
   wherein the magnets are configured such that their rotation relative to the object induces one or more electrical currents in the object, the, or
each electrical current creating a magnetic field, such that a force is applied to the structure; and
rotatably mounting the one or more magnets with respect to at least part of the structure; and
rotating the magnets relative to the object.

Embodiments of the eighth aspect of the present invention may include one or more features of the first, second, third, fourth, fifth, sixth and/or seventh aspects of the present invention or their embodiments. Similarly, embodiments of the first, second, third, fourth, fifth, sixth and/or seventh aspects of the present invention may include one or more features of the eighth aspect of the present invention or its embodiments.

According to a ninth aspect of the present invention, there is provided a method of applying a force to a rail vehicle on a track, the method comprising the steps of:
providing an apparatus for applying a force to a rail vehicle on a track, the apparatus comprising:
   one or more magnets, the one or more magnets being rotatably mountable with respect to at least part of the rail vehicle,
   wherein the track comprises one or more electrically conductive portions;
   wherein the magnets are configured such that their rotation relative to the track induces one or more electrical currents in the track, the, or each electrical current creating a magnetic field, such that a force is applied to the rail vehicle; and
rotatably mounting the one or more magnets with respect to at least part of the rail vehicle;
using the apparatus to rotate the one or more magnets with respect to at least a part of the rail vehicle.

Embodiments of the ninth aspect of the present invention may include one or more features of the first, second, third, fourth, fifth, sixth, seventh and/or eighth aspects of the present invention or their embodiments. Similarly, embodiments of the first, second, third, fourth, fifth, sixth, seventh and/or eighth aspects of the present invention may include one or more features of the ninth aspect of the present invention or its embodiments.

According to a tenth aspect of the present invention there is provided a method of applying a force to a levitation vehicle on a track, the method comprising the steps of:
providing an apparatus for applying a force to a levitation vehicle on a track, the apparatus comprising:
   one or more magnets, the one or more magnets being rotatably mountable with respect to at least part of the levitation vehicle,
   wherein the track comprises one or more electrically conductive portions;
   wherein the magnets are configured such that their rotation relative to the track induces one or more electrical currents in the track, the, or each electrical current creating a magnetic field, such that a force is applied to the levitation vehicle; and
rotatably mounting the one or more magnets with respect to at least part of the levitation vehicle; and
using the apparatus to rotate the one or more magnets with respect to at least a part of the levitation vehicle.

Embodiments of the tenth aspect of the present invention may include one or more features of the first, second, third, fourth, fifth, sixth, seventh, eighth and/or ninth aspects of the present invention or their embodiments. Similarly, embodiments of the first, second, third, fourth, fifth, sixth, seventh, eighth and/or ninth aspects of the present invention may include one or more features of the tenth aspect of the present invention or its embodiments.

According to an eleventh aspect of the present invention there is provided a method of applying a force to a vehicle on a track, the method comprising the steps of:
providing an apparatus for applying a force to a vehicle on a track, the apparatus comprising:
   one or more magnets being mountable with respect to at least part of the vehicle; and
   wherein the track comprises one or more electrically conductive portions;
wherein the magnets are configured such that they induce one or more electrical currents in the track, the, or each electrical current creating a magnetic field, such that a force is applied to the vehicle; and
mounting the one or more magnets with respect to at least part of the vehicle.

Embodiments of the eleventh aspect of the present invention may include one or more features of the first, second, third, fourth, fifth, sixth, seventh, eighth, ninth and/or tenth aspects of the present invention or their embodiments. Similarly, embodiments of the first, second, third, fourth, fifth, sixth, seventh, eighth, ninth and/or tenth aspects of the present invention may include one or more features of the eleventh aspect of the present invention or its embodiments.

According to a twelfth aspect of the present invention, there is provided a method of applying a force to a structure, the method comprising the steps of: providing an apparatus for applying a force to a structure, the apparatus comprising:
one or more magnets being mountable with respect to at least part of the structure; and
wherein the structure is locatable on or adjacent to an object, the object comprising one or more electrically conductive portions;
   wherein the magnets are configured such that they induce one or more electrical currents in the object, the, or each electrical current creating a magnetic field, such that a force is applied to the structure; and
   mounting the one or more magnets with respect to at least part of the structure.

Embodiments of the twelfth aspect of the present invention may include one or more features of the first, second, third, fourth, fifth, sixth, seventh, eighth, ninth, tenth and/or eleventh aspects of the present invention or their embodiments. Similarly, embodiments of the first, second, third, fourth, fifth, sixth, seventh, eighth, ninth, tenth and/or eleventh aspects of the present invention may include one or more features of the twelfth aspect of the present invention or its embodiments.

According to a thirteenth aspect of the present invention, there is provided a vehicle comprising:
an apparatus for applying a force to the vehicle on a track, the apparatus comprising:
   one or more magnets, the one or more magnets being rotatably mountable with respect to at least part of the vehicle,
   wherein the track comprises one or more electrically conductive portions,
   wherein the magnets are configured such that their rotation relative to the track induces one or more electrical currents in the track, such that a force is applied to the vehicle.

Embodiments of the thirteenth aspect of the present invention may include one or more features of the first, second, third, fourth, fifth, sixth, seventh, eighth, ninth, tenth, eleventh and/or twelfth aspects of the present invention or their embodiments. Similarly, embodiments of the first, second, third, fourth, fifth, sixth, seventh, eighth, ninth, tenth, eleventh and/or twelfth aspects of the present invention may include one or more features of the thirteenth aspect of the present invention or its embodiments.

According to a fourteenth aspect of the present invention, there is provided a structure comprising:
an apparatus for applying a force to the structure, the apparatus comprising:
   one or more magnets, the one or more magnets being rotatably mountable with respect to at least part of a structure,
   wherein the structure is locatable on or adjacent to an object, the object comprising one or more electrically conductive portions;
   wherein the magnets are configured such that their rotation relative to the object induces one or more electrical currents in the object, the, or each electrical current creating a magnetic field, such that a force is applied to the structure.

Embodiments of the fourteenth aspect of the present invention may include one or more features of the first, second, third, fourth, fifth, sixth, seventh, eighth, ninth, tenth, eleventh, twelfth and/or thirteenth aspects of the present invention or their embodiments. Similarly, embodiments of the first, second, third, fourth, fifth, sixth, seventh, eighth, ninth, tenth, eleventh, twelfth and/or thirteenth aspects of the present invention may include one or more features of the fourteenth aspect of the present invention or its embodiments.

According to a fifteenth aspect of the present invention, there is provided a rail vehicle comprising:
an apparatus for applying a force to the rail vehicle on a track, the apparatus comprising:
   one or more magnets, the one or more magnets being rotatably mountable with respect to at least part of the rail vehicle,
   wherein the track comprises one or more electrically conductive portions; and
   wherein the magnets are configured such that their rotation relative to the track induces one or more electrical currents in the track, the, or each electrical current creating a magnetic field, such that a force is applied to the rail vehicle.

Embodiments of the fifteenth aspect of the present invention may include one or more features of the first, second, third, fourth, fifth, sixth, seventh, eighth, ninth, tenth, eleventh, twelfth, thirteenth and/or fourteenth aspects of the present invention or their embodiments. Similarly, embodiments of the first, second, third, fourth, fifth, sixth, seventh, eighth, ninth, tenth, eleventh, twelfth, thirteenth and/or fourteenth aspects of the present invention may include one or more features of the fifteenth aspect of the present invention or its embodiments.

According to a sixteenth aspect of the present invention, there is provided a levitation vehicle comprising:
an apparatus for applying a force to the levitation vehicle on a track, the apparatus comprising:
   one or more magnets, the one or more magnets being rotatably mountable with respect to at least part of the levitation vehicle,
   wherein the track comprises one or more electrically conductive portions,
   wherein the magnets are configured such that their rotation relative to the track induces one or more electrical currents in the track, the, or each electrical current creating a magnetic field, such that a force is applied to the levitation vehicle.

Embodiments of the sixteenth aspect of the present invention may include one or more features of the first, second, third, fourth, fifth, sixth, seventh, eighth, ninth, tenth, eleventh, twelfth, thirteenth, fourteenth and/or fifteenth aspects of the present invention or their embodiments. Similarly, embodiments of the first, second, third, fourth, fifth, sixth, seventh, eighth, ninth, tenth, eleventh, twelfth, thirteenth, fourteenth and/or fifteenth aspects of the present invention may include one or more features of the sixteenth aspect of the present invention or its embodiments.

According to a seventeenth aspect of the present invention there is provided a vehicle comprising:
an apparatus for applying a force to a vehicle on a track, the apparatus comprising:
   one or more magnets being mountable with respect to at least part of the vehicle; and
   wherein the track comprises one or more electrically conductive portions; and
wherein the magnets are configured such that they induce one or more electrical currents in the track, the, or each electrical current creating a magnetic field, such that a force is applied to the vehicle.

Embodiments of the seventeenth aspect of the present invention may include one or more features of the first, second, third, fourth, fifth, sixth, seventh, eighth, ninth, tenth, eleventh, twelfth, thirteenth, fourteenth, fifteenth, and/or sixteenth aspects of the present invention or their embodiments. Similarly, embodiments of the first, second, third, fourth, fifth, sixth, seventh, eighth, ninth, tenth, eleventh, twelfth, thirteenth, fourteenth, fifteenth and/or sixteenth aspects of the present invention may include one or more features of the seventeenth aspect of the present invention or its embodiments.

According to an eighteenth aspect of the present invention there is provided a structure comprising:
an apparatus for applying a force to the structure, the apparatus comprising:
   one or more magnets being mountable with respect to at least part of the structure; and
   wherein the structure is locatable on or adjacent to an object, the object comprising one or more electrically conductive portions; and
wherein the magnets are configured such that they induce one or more electrical currents in the object, the, or each electrical current creating a magnetic field, such that a force is applied to the structure.

Embodiments of the eighteenth aspect of the present invention may include one or more features of the first, second, third, fourth, fifth, sixth, seventh, eighth, ninth, tenth, eleventh, twelfth, thirteenth, fourteenth, fifteenth, sixteenth and/or seventeenth aspects of the present invention or their embodiments. Similarly, embodiments of the first, second, third, fourth, fifth, sixth, seventh, eighth, ninth, tenth, eleventh, twelfth, thirteenth, fourteenth, fifteenth, sixteenth and/or seventeenth aspects of the present invention may include one or more features of the eighteenth aspect of the present invention or its embodiments.

### BRIEF DESCRIPTION OF THE DRAWINGS

Embodiments of the invention will now be described, by way of example, with reference to the drawings, in which:

FIG. 1 shows an apparatus for applying a force to a vehicle, according to an aspect of the invention;

FIG. 2a shows a schematic illustration of another embodiment of the apparatus of FIG. 1;

FIG. 2b shows a partial view of the electrical power module of the control system of the apparatus of FIG. 1;

FIGS. 3a and 3b show a further embodiment of the apparatus of FIG. 1;

FIG. 4 illustrates example two phase, three phase and four phase magnet configurations of the apparatus of FIG. 3a;

FIG. 5 illustrates another embodiment of the apparatus of FIG. 1;

FIG. 6 illustrates another embodiment of the apparatus of FIG. 1, using a single Bitter electromagnet;

FIG. 7 illustrates a side view of another embodiment of the apparatus of FIG. 1; and

FIG. 8 illustrates another embodiment of the apparatus of FIG. 1, including a traction assistance device.

### DESCRIPTION OF EMBODIMENTS

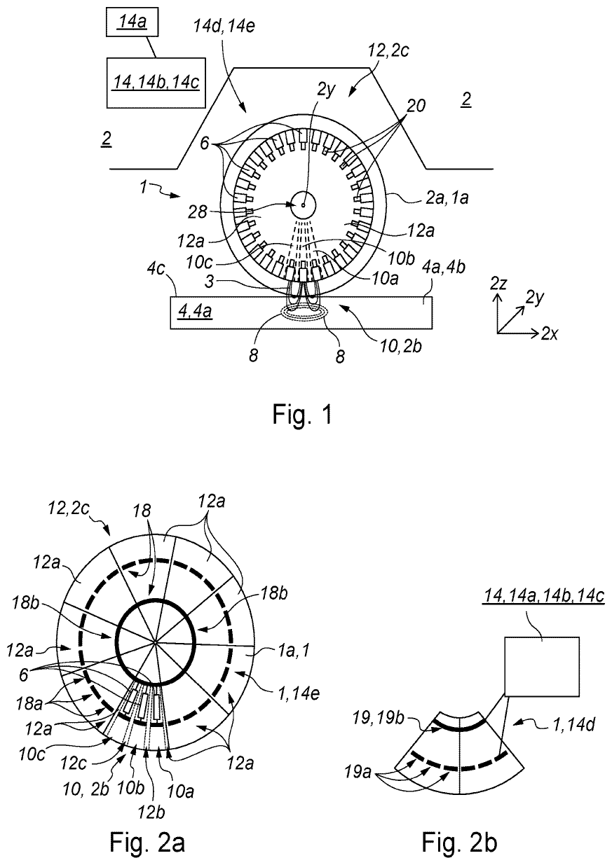

With reference to FIGS. 1 to 8, an apparatus 1 for applying a force to a vehicle 2 on a track 4 is illustrated.

In the embodiments illustrated and described here, the apparatus 1 comprises one or more magnets 6, which are rotatably mountable with respect to at least part of the vehicle 2. In the embodiments illustrated and described here, the magnets 6 are electromagnets. In other embodiments, other types of magnets, either permanent or non-permanent, could be used.

The track 4 comprises one or more electrically conductive portions 4a and the magnets 6 are configured such that their rotation relative to the track 4 induces one or more electrical currents 8 in the track 4, such that a force is applied to the vehicle 2. The present invention can be used in this manner to improve the traction of the vehicle 2 to the track 4.

The apparatus 1 functions using the following principles. The magnets 6 are configured such that their rotation relative to the track 4 induces one or more electrical currents 8 in the track 4, in accordance with Faraday's law of induction. The one or more electrical currents 8 in the track 4 create a magnetic field 3, in accordance with Ampere's circuital law such that a magnetic field is applied to the vehicle 2. The direction of the induced electrical current and thus the direction of the magnetic field produced by the induced current 8 is determined by Lenz's law. Thus, rotation of the magnets 6 relative to the track 4 applies a force to the vehicle 2. It will be understood that depending on the properties of the magnets 6, the rate of rotation, the direction of rotation, and the properties of the vehicle 2, apparatus 1 and track 4, that the direction and/or magnitude of the force can be variable and can be configured in a number of ways. In this arrangement, the operation of the apparatus 1 results in magnetic friction and/or magnetic attraction between the vehicle 2 and the track 4.

In the embodiments illustrated and described here, the apparatus 1 is operable to provide an attractive force and/or a repulsive force between the vehicle 2 and the track 4, in accordance with Coulomb's law.

In the embodiments illustrated and described here, the vehicle 2 is a rail vehicle, such as a train, comprising a plurality of wheels 2a, and the vehicle 2 is configured to run on at least two rail members 4b of the track 4. It will be appreciated that a wide variety of vehicles 2 and tracks 4 could be used. For example, the vehicle 2 may be a levitation vehicle, such as a levitation train, maglev train, or the like, which runs on the track 4, the track 4 being a guide for the levitation vehicle. In that example, the levitation vehicle runs on the track 4 but is not in contact with the track 4. Thus, the levitation vehicle is operable to levitate adjacent to at least a portion of the track 4.

In the embodiments illustrated and described here, the track 4 is a metallic track 4 formed of steel.

The apparatus 1 is operable to apply magnetic friction between the vehicle 2 and the track 4, and is operable in use to increase the magnetic friction between the vehicle 2 and the track 4, such as by increasing the magnetic field 3 strength of the magnets 6. In this way, the apparatus 1 is operable to increase the traction of the vehicle 2 to the track 4. In the embodiments illustrated and described here, in which the vehicle 2 is in contact with the track 4, the apparatus 1 is operable to increase the contact friction between one or more surfaces of the wheels 2a of the vehicle 2, and the track 4.

Whilst the apparatus 1 is operable to improve traction, the apparatus 1 is also operable to provide propulsion, acceleration and/or braking to the vehicle 2.

The apparatus 1 includes a frame member 1a and each magnet 6 is located thereon.

The magnets 6 are configured such that their rotation relative to the track 4 induces one or more electrical eddy currents 8 in at least a portion of the track 4, and the one or more electrically conductive portions 4a of the track 4 are arranged such that rotation of the magnets 6 relative thereto induces the one or more electrical eddy currents 8 in the, or each, electrically conductive portions 4a of the track 4.

In the embodiments illustrated and described here, the electrically conductive portions 4a of the track 4 include one or more planar upper surfaces 4c located adjacent to the vehicle 2 when the vehicle is located 2 on or adjacent to the track 4. The upper surface 4c is in contact with the wheels 2a of the vehicle 2. In other embodiments, the electrically conductive portions 4a of the track 4 could be arranged to be insulated from the vehicle 2, such as by being spaced therefrom, or by being embedded within an insulating material.

In the embodiments illustrated in FIGS. 1 to 8 the apparatus 1 is operable, in use, to apply a variable, or alternating, magnetic field 3 to the track 4, which induces a variable, or alternating, electrical current 8 in the track 4, which in turn provides a variable, or alternating magnetic field to the wheel(s) 2a of the vehicle 2, in accordance with Faraday's law of induction, Ampere's circuital law and Lenz's law. In these embodiments, applying a variable or alternating, magnetic field 3 to the track 4 can result in magnetic friction and/or magnetic attraction. It will be appreciated that the variable or alternating magnetic field 3 can be provided by the apparatus 1 by moving the magnets 6 and/or by varying the magnetic properties thereof (e.g. by varying the magnetic field 3 intensity and/or magnetic polarity of the magnets 6).

In the embodiments illustrated and described here, the apparatus 1 is operable to vary the magnetic field 3 strength and/or to switch the magnetic polarity of each magnet 6.

The apparatus 1 can comprise any suitable number of magnets 6.

Each magnet 6 includes at least one north pole and at least one south pole, although the polarity is reversible, for example, by using an alternating current to drive the electromagnets 6. Due to the use of electromagnets, each magnet 6 is configurable between an on state, in which the magnet 6 produces a magnetic field 3, and an off state, in which the magnet 6 does not produce a magnetic field. Therefore, in the embodiments illustrated and described herein, each magnet 6 is configurable between the on state and the off state, and the apparatus 1 is operable to vary the magnetic field 3 strength of each magnet 6 and the apparatus is operable to switch the magnetic polarity of each magnet 6.

The apparatus 1 is operable to independently switch all of the magnets 6 between the on state and the off state, to independently vary the magnetic field 3 strength of each magnet 6 and to independently switch the magnetic polarity of each magnet 6.

The vehicle 2 comprises an x-axis 2x, a y-axis 2y and a z-axis 2z, which are orthogonal. In the embodiments illustrated and described here, the vehicle 2 moves relative to the track 4 substantially in the direction of the x-axis 2x thereof. However, it should be appreciated that in other embodiments, the vehicle 2 could be configured to move relative to the track 4 substantially in the direction of the x-axis 2x, y-axis 2y, and/or z-axis 2z. The z-axis 2z is the vertical axis of the vehicle 2.

The length of the vehicle 2 is along the x-axis 2x, the width of the vehicle 2 is along the y-axis 2y and the height of the vehicle is along the z-axis 2z.

The wheels 2a of the vehicle 2 are configured to rotate about the y-axis 2y of the vehicle 2. However, it should be appreciated that in other embodiments, the wheels 2a of the vehicle 2 could be configured to rotate about the x-axis 2x, y-axis 2y and/or z-axis 2z of the vehicle 2.

Each wheel 2a of the vehicle 2 has a plane of rotation in the x-z plane of the vehicle 2. In other embodiments, the plane of rotation of each wheel 2a of the vehicle 2 could be in the x-z plane, x-y plane and/or y-z plane of the vehicle 2.

The magnets 6 are arranged to rotate fully about the y-axis 2y of the vehicle 2. However, it should be appreciated that in other embodiments, the magnets 6 could be arranged to rotate partially about at least one axis of rotation, and could be arranged to rotate about the x-axis 2x, y-axis 2y and/or z-axis 2z of the vehicle 2. In the embodiments illustrated and described here, the axis of rotation of the magnets 6 is therefore co-axial with the axis of rotation of the wheels 2a of the vehicle 2. In other embodiments, the axes of rotation of the magnets 6 and the wheel 2a of the vehicle 2 could be different, or offset from one another.

In the embodiments illustrated and described here, the magnets 6 have a single plane of rotation, which is an x-z plane of the vehicle, which is co-planar with the plane of rotation of the wheels 2a of the vehicle 2. In other embodiments, the plane of rotation of the magnets 6 could be an x-z plane of the vehicle 2, an x-y plane of the vehicle 2, and/or a y-z plane of the vehicle 2.

In the embodiments illustrated in FIGS. 1 and 2a, the apparatus 1 comprises one or more activation zones 10 and one or more deactivation zones 12. Each activation zone 10 and each deactivation zone 12 are defined by sectors of the plane of rotation of the magnets 6. The activation zones 10 and the deactivation zones 12 are also defined by the rotational angle of each magnet 6 relative to the plane of rotation of each magnet 6. The activation zones 10 and the deactivation zones 12 could be located at any suitable rotational angle.

The apparatus 1 is operable to configure each magnet 6 in the on state when each magnet 6 is located within the one or more activation zones 10 and to configure each magnet 6 in the off state when each magnet 6 is located within the one or more deactivation zones 12.

The apparatus 1 is operable to activate and/or deactivate each magnet 6 at least once during the rotation of the magnets 6.

In the embodiments illustrated in FIGS. 1 and 2a, the apparatus 1 is configured to activate each magnet 6 only when the magnet 6 is located in an activation zone 10. In this arrangement, the magnets 6 located in the activation zones 10 are activated and the magnets located in the deactivation zones 12 are not activated.

The apparatus 1 is configured to activate each magnet 6 during at least part of the rotation cycle of each magnet 6.

In the embodiment illustrated in FIG. 8, the apparatus 1 is configured to activate each magnet 6 during the entire rotation cycle of each magnet 6. In this embodiment, the magnets 6 are active at all times, provided the apparatus 1 is in use. How the apparatus 1 itself may be switched on or off is described in further detail below.

The apparatus 1 comprise an electronic control system 14 operable to selectively activate each magnet 6. In the embodiments illustrated in FIGS. 1 and 2a, the control system 14 is configured to automatically activate each magnet 6 as each magnet 6 is moved into an activation zone 10 and to automatically deactivate each magnet 6 as each magnet 6 is moved into a deactivation zone 12.

The control system 14 is mountable to the vehicle 2 and is located thereon.

The apparatus 1 is operable between an on condition, in which each magnet 6 is capable of being activated, and an off condition, in which the apparatus 1 is off and each magnet 6 cannot be activated. The control system 14 includes a control element 14a operable to switch the apparatus 1 between the on condition and the off condition.

In the embodiments illustrated in FIGS. 1 and 2a, the activation zones 10 are located at a lower region 2b of a wheel 2a of the vehicle 2. That is, at a region of the vehicle 2 that is, in use, adjacent to at least a portion of the track 4. The activation zones 10 are also located at a lower region of the plane of rotation of the magnets 6. In this way, the magnets 6 are activated when located close to the track 4 and are deactivated when less effective. This makes the apparatus 1 more efficient.

In the embodiments illustrated and described here, the apparatus 1 comprises a deactivation zone 14 located at an upper region 2c of the wheel 2a of the vehicle 2. In the embodiments illustrated in FIGS. 1 and 2a, the apparatus 1 comprises one or more activation zones 10 located proximal to the track 4, one or more deactivation zones 12 located proximal to the track 4, and one or more deactivation zones 12 located distal to the track 4.

In the embodiments illustrated in FIGS. 1 and 2a, the apparatus 1 is configured such that each magnet 6 is activated for a shorter period of time than it is deactivated.

The apparatus 1 comprise a first activation zone 10a, a second activation zone 10b, a third activation zone 10c, a first deactivation zone 12a, a second deactivation zone 12b, and a third deactivation zone 12c.

The second deactivation zone 12b and the third deactivation zones 12c are designed to prevent short circuiting of the electromagnets 6, and are arranged to be smaller in area than the first activation zone 12a, which is primarily designed to save energy by deactivating the electromagnets 6 when located at the upper region 2c of the wheels 2a.

The first activation zone 10a, the second activation zone 10b and the third activation zone 10c are substantially identical in size. It will be understood that in other embodiments the first activation zone 10a, the second activation zone 10b, and the third activation zone 10c could differ in size.

The first deactivation zone 12a is arranged to cover at least the upper 50% of the plane of rotation of the magnets 6.

Whilst in the embodiments illustrated in FIGS. 1 to 5, 7 and 8, electromagnets 6 comprising copper windings are used, it will be appreciated that a superconducting magnet, a ceramic magnet, or a superconducting ceramic magnet could be used, and indeed other types of magnets 6 could be employed, including electromagnets 6 having different properties to those illustrated and described herein.

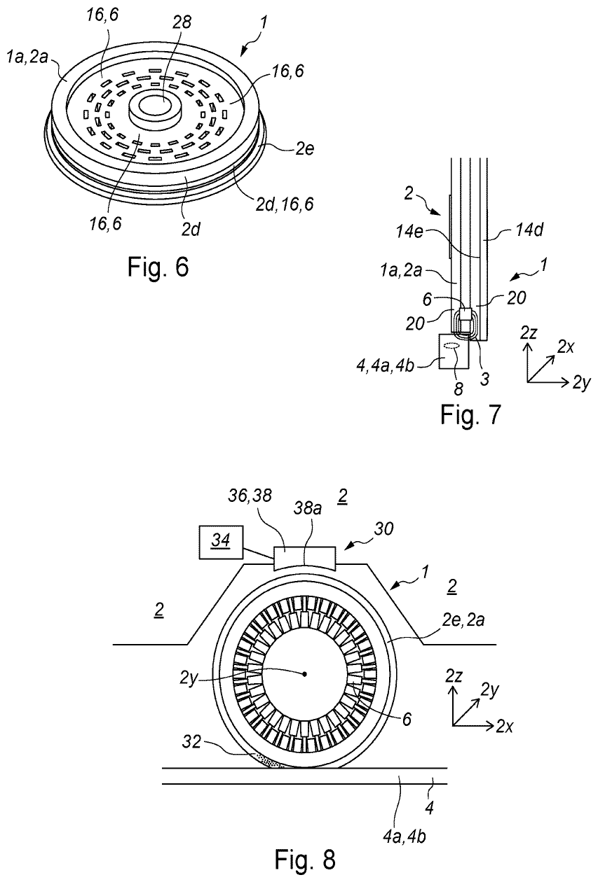

In the alternative embodiment illustrated in FIG. 6, the apparatus 1 comprises a single magnet 6, which is a Bitter electromagnet. The Bitter electromagnet comprise a base 16 arranged in the x-z plane and arranged to be coplanar with the plane of rotation of the wheel 2a of the vehicle 2.

With continued reference to FIG. 6, the Bitter electromagnet is integrally formed with a wheel 2a of the vehicle 2. In the embodiment illustrated here, the Bitter electromagnet is made from copper, although other suitable metals could be used.

As shown in FIGS. 1 to 8, each magnet 6 is a discrete magnetic component.

The control system 14 comprises one or more sensors 14b configured to detect one or more low-adhesion events, such as when the traction of a wheel 2a of the vehicle 2 is below a threshold value. The sensors 14b are electronic sensors operable to provide an alert when the low-adhesion event occurs and to alert a user of the vehicle 2, optionally the driver thereof, of the low-adhesion event and to prompt the driver (or another user) to activate the apparatus 1. However, the control system could be configured to automatically activate and deactivate the apparatus 1 in response to received data from the sensors 14b. The sensors 14b are typically selected from: a revolution counter device, a tachometer, a rev counter device, an RPM counter device, and a wheel encoder, or the like, although it will be understood that other sensors 14b could be used.

The apparatus 1 is connectable to a source of electrical power. In the embodiments illustrated and described here, the source of electrical power is an alternating current (a.c.) power supply, and is either a three phase supply or a four phase supply. FIG. 4 is a schematic illustrating three example arrangements of two phase, three phase and four phase magnet 6 configurations, and it will be understood that many possible configurations of power supply and magnets 6 are possible.

The three phase power supply includes phase A, phase B and phase C supply lines, which are offset by 120 degrees. The four phase power supply includes phase A, phase B, Phase C and Phase D supply lines offset by 90 degrees.

The electrical power source is arranged as a star supply, and the magnets 6 are also arranged in a star connection. It will be appreciated that a delta connection could be used for the power source and/or the magnets 6.

The source of electrical power is obtained from an on-board vehicle power supply.

The control system 14 comprises one or more power management modules 14c configured to manage the electrical power from the source of electrical power and provide suitable electrical power to each magnet 6.

The control system 14 comprises an electrical power module 14d configured to provide the electrical power to each magnet 6. The electrical power module 14d is mountable to the vehicle 2 and is fixedly attachable to the vehicle 2.

The electrical power module 14d is locatable adjacent to the magnets 6 of the apparatus 1 and the frame member 1a of the apparatus 1. The electrical power module 14d is located at a wheel 2a of the vehicle 2 and is a substantially disc shaped member. The electrical power module 14d is arranged to be stationary relative to the vehicle 2 when mounted thereto. The apparatus 1 is configured such that the magnets 6 rotate relative to the electrical power module 14d.

As best shown in FIGS. 1, 2a, 7, and in some embodiments, the control system 14 comprises a slip ring 14e (an example of a selection device) operable to selectively provide electrical power from the electrical power module 14d to the magnets 6. In other embodiments, the selection device could comprise one or more wireless power transfer links, either as an alternative to the slip ring 14e, or in combination therewith. The slip ring 14e is configured to define the location of the activation zones 10a, 10b, 10c. and the deactivation zones 12a, 12b, 12c.

The slip ring 14e comprises one or more electrical connection points 18 connected to at least one of the magnets 6 and one or more electrical connection points 19 connected to the electrical power module 16d. The slip ring 14e is operable to selectively connect and disconnect each magnet 6 to or from the electrical power module 14d via the electrical connection points 18, 19.

FIG. 2a shows a schematic representation of the slip ring 14e, which is connected and opposed to the electrical power module shown 14d partially in FIG. 2b. In the embodiments shown in FIG. 2a, the slip ring 14e is arranged such that, as the magnets 6 rotate, the electrical connection points 18 of the magnet 6 connect with, and disconnect from, the electrical connection points 19 of the electrical power module 14d when each, magnet 6 is in the activation zones 10a, 10b, 10c, and to disconnect the electrical connection points 19 of the electrical power module 14d and the electrical connection points 18 of each magnet 6, when each magnet 6 is in the deactivation zones 12a, 12b, 12c.

The control system 14 is operable to activate or deactivate one or more of the electrical connection points 19 of the electrical power module 14d. In this arrangement, the control system 14 can determine the location of the activation 10 and deactivation zone(s) 12, which can be adjusted, optionally during use of the apparatus 1. This may be advantageous in those embodiments where the rotation of the magnets 6 is out of sync with the rotation of the wheels 2a of the vehicle 2.

In the embodiments shown in FIGS. 2a and 2b, the electrical connection points 18 of each magnet 6 each include one or more first electrodes 18a and one or more second electrodes 18b. The first electrode 18a is the signal electrode and the second electrode 18b is a common, or return, electrode. The second electrode 18b is common to all of the magnets 6. Similarly, the electrical connection points 19 of the electrical power module 14d, each include a first electrode 19a and a second electrode 19b. The first electrode 19a is the signal electrode and the second electrode 19b is a common, or return, electrode common to all electrical connection points 19 of the electrical power module 14d.

The slip ring 14e is configured to selectively connect the first electrodes 18a of each magnet 6 to the first electrodes 19a of the electrical power module 14d. It will be understood that a wireless power transfer link could be used either in addition to, or as an alternative to, the slip ring 14e to carry out this function.

It will be understood that in the embodiment shown in FIGS. 2a and 2b, the second electrodes 18b of the magnets 6 and the second electrodes 19b of the electrical power module 14d are arranged to always be in electrical communication with each other. However, in other embodiments, the slip ring 14e, or other selection device, could be configured to selectively connect the second electrodes 18b, 19b.

In the embodiments shown in FIGS. 2a and 2b, the cross-sectional contact area of the signal electrodes 18a of the magnets 6 is arranged to be smaller than the cross-sectional contact area of the signal electrodes 19a of the electrical power module 14d.

The electrical connection points 18 of the magnets 6 are located on a first planar surface of the frame member 1a and the electrical connection points 19 of the electrical power module 14d are located on a first planar surface thereof. The first planar surfaces of the frame member 1a and the electrical power module 14d are arranged to be opposed surfaces, adjacent to each other.

The first and second electrodes 18a, 18b, of the magnets 6 are arranged in a circular arrangement arranged radially with respect to the plane of rotation of the magnets 6. Similarly, the first and second electrodes 19a, 19b, of the electrical power module 14d are arranged in a circular arrangement arranged radially with respect to the plane of rotation of the magnets 6.

In the embodiments illustrated in FIGS. 1 and 2a, each activation zone 10 is associated with a phase line of the power supply. The control system 14 is configured to apply a first phase to each magnet 6 when located in the first activation zone 10a, a second phase to each magnet 6 when located in the second activation zone 10b, and a third phase to each magnet 6 when located in the third activation zone 10c. The first phase may be phase A, phase B, or phase C. The second phase may be phase A, phase B or Phase C. The third phase may be phase A, phase B or phase C. In the embodiments shown here, the first phase is phase A, the second phase is phase B and the third phase may be phase C. In other embodiments, such as that shown in FIG. 4, multiple phases may be activated in each activation zone 10.

Thus, in the embodiment shown in FIGS. 1 to 4, the control system 14 is operable to apply a first phase to a first magnet, a second phase to a second magnet, and a third phase to a third magnet. The magnets 6 are distributed in a sequence of first, second and third magnets. The first phase and second phase are offset by 120 degrees. The second phase and third phase are offset by 120 degrees. The third and the first phase are offset by 120 degrees.

In the embodiment illustrated in FIG. 4, the control system 14 is operable to apply a fourth phase to a fourth magnet. In this embodiment, the magnets 6 may be distributed in a sequence of first, second, third and fourth magnets. The first phase and second phase are offset by 90 degrees. The second and third phase are offset by 90 degrees. The third and the fourth phase are offset by 90 degrees. The fourth and the first phase are offset by 90 degrees. It will be understood that three possible examples are shown in FIG. 4, but more example arrangements are possible.

In the embodiments illustrated in FIGS. 1, 2a, 3a 4, 5 and 8, the magnets 6 are radially distributed in the x-z plane.

With reference to FIGS. 1 to 5, and FIG. 8, the control system 14 is operable to connect each magnet 6 to any one of the phases of the electrical power supply. The control system 14 is configured to switch each magnet 6 from a first phase of electrical power supply to a second phase of electrical power supply, and to switch each magnet from a second phase of electrical power supply to a third phase of electrical power supply, and to switch each magnet 6 from a third phase of electrical power supply to a first phase of electrical power supply. It will be appreciated that this happens as each magnet 6 moves between the activation zones 10a, 10b, 10c.

In the embodiments illustrated in FIGS. 1 to 3a, the apparatus 1 is configured such that each magnet 6 has no predetermined electrical phase. In this arrangement each magnet 6 is connectable to any electrical phase line during the operation of the apparatus 1.

In the embodiment shown in FIGS. 1 and 2a, the apparatus 1 is configured to connect the magnets 6 in a three phase star connection when the magnets 6 are located in the activation zones 10. In this arrangement, one or more magnets 6 are connected to phase A and the common line, one or more magnets 6 are connected to phase B and the common line, and one or more magnets 6 are connected to phase C and the common line. However, it should be understood that the magnets 6 may be arranged in a three phase delta connection when the magnets 6 are located in the activation zones 10.

As best shown in the embodiments depicted in FIGS. 1 and 7, the apparatus 1 is configured to apply a magnetic field 3 from the one or more magnets 6 radially at least partially in the x-z plane.

In the embodiments illustrated and described here, the apparatus 1 is configured to apply a magnetic field 3 from the, or each, magnet 6 substantially towards the track 4, and is configured to direct the magnetic field 3 towards the track 4.

As best shown in the embodiment illustrated in FIG. 7, the magnets 6 are arranged to provide a magnetic field 3 component that is substantially along the z-axis 2z of the vehicle 2. It will be understood that the magnets 6 could be arranged to provide a magnetic field 3 component that is substantially along the y-axis 2y of the vehicle 2, the z-axis 2z of the vehicle and/or along the x-axis 2x of the vehicle 2. The magnets 6 are arranged to provide a magnetic field 3 component that is perpendicular to the direction of travel of the vehicle 2, and are arranged to provide a magnetic field 3 component that is directed towards the contact point of the wheel 2a of the vehicle 2 with the track 4.

In the embodiments shown in FIGS. 1 to 5, the magnets 6 are rotationally offset from each other in the x-z plane. The magnets 6 are rotationally offset about the axis of rotation (the y-axis 2y of the vehicle) of the magnets 6. In the embodiment shown in FIGS. 1 to 3a, the magnets 6 are arranged with one pole proximal to the axis of rotation and one pole distal to the axis of rotation.

In the embodiment shown in FIGS. 1 to 8, the magnets 6 are arranged to focus the magnetic field 3 towards the track 4 and complete a magnetic circuit between the magnets 6, the wheel 2a of the vehicle 2, and at least a portion of the track 4.

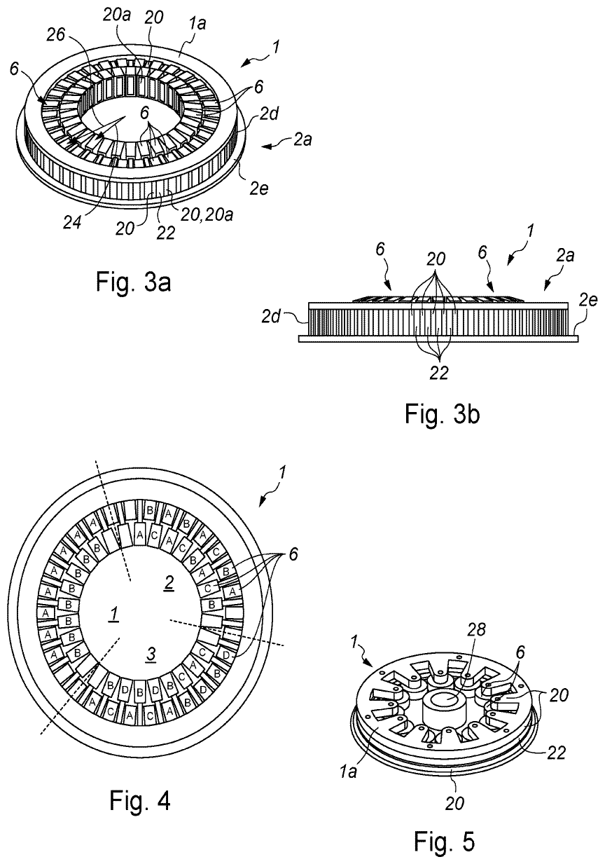

In some embodiments, and as best shown in FIGS. 3a, 3b and 5, the apparatus 1 comprises one or more magnetic guide elements 20 configured to guide, or direct, or focus the magnetic field 3 from the, or each, magnet 6 towards the track 4. Each magnetic guide element 20 is made from 1080 carbon steel, although it will be understood that other materials could be used. With continued reference to FIGS. 3a, 3b and 5, the apparatus 1 comprises one or more magnetic shield elements 22 arranged to reduce the magnetic coupling between two or more magnets 6 and arranged to reduce the magnetic coupling between two or more magnetic guide elements 20. The magnetic shield elements 22 are made from 304 stainless steel, although other materials could be used.

In the embodiment shown in FIGS. 3a, 3b and 5, each magnetic guide element 20 is arranged such that at least a portion thereof is adjacent to, and in contact with, at least a portion of the track 4. Likewise, each magnetic shield element 22 is arranged such that at least a portion thereof is adjacent to, and in contact with, at least a portion of the track 4.

In the embodiment shown in FIGS. 1, 3a, 3b, 5, and 7, each magnetic guide element 20 is configured to be fixed relative to each magnet 6. In this embodiment, the magnetic guide elements 20 rotate with the magnets 6. Likewise, the magnetic shield elements 22 are configured to be fixed relative to the magnets 6, such that the magnetic shield elements 22 rotate with the magnets 6.

In the embodiment shown in FIG. 5, the magnets 6 share a common magnetic guide element 20 and a common magnetic shield element 22.

In the embodiment illustrated in FIG. 3a, One or more of the magnets 6 are arranged at a first radius 24 from the axis of rotation and one or more of the magnets 6 are arranged at a second radius 26 from the axis of rotation. The magnets 6 of the first radius 24 are associated with one or more first magnetic guide members 20a. At least a part of each first magnetic guide member 20a may be arranged between two or more of the magnets 6 of the second radius 26. The magnetic guide members 20, 22a include one or more elongate members.

In the embodiment shown in FIGS. 3a, 3b and 5, at least a part of the magnetic guide members 20 forms part of the structure of the wheel 2a of the vehicle 2, and as such, at least a part of the magnetic guide members 20 is configured to run on the track 4. Specifically, at least a part of the magnetic guide members 20 forms at least a part of a tread portion 2d and at least a portion of a flange portion 2e of the wheel 2a of the vehicle 2.

The frame member 1a is a rotor, as it is rotatable, and is configured to accommodate the magnets therein. The frame member 1a is a housing for the magnets 6. The frame member 1a is substantially disc shaped. In the embodiments illustrated and described here, the frame member 1a is integrally formed with the wheel 2a of the vehicle 2. In other embodiments, the frame member 1a is mountable to the vehicle 2, which makes it suitable for retrofitting thereto.

The frame member 1a is mountable to a corresponding frame member receiving apparatus of the vehicle 2. The frame member receiving apparatus is an axle of the wheel 2a of the vehicle 2 configured to rotate the frame member 1a and to not rotate the electrical power module 14d. The frame member 1a includes a through bore 28 (an example of an engagement portion) configured to engage with the frame member receiving apparatus of the vehicle 2.

The vehicle 2 comprises a motor operable to rotate the magnets 6 when rotatably mounted to the vehicle 2 and to rotate a wheel 2a of the vehicle 2. In other embodiments, the magnets 6 may be rotated by a separate motor to that used to rotate the wheels 2a of the vehicle 2.

The axis of rotation of the magnets 6 and the axis of rotation of the wheels 2a of the vehicle 2 are coaxial. However, in other embodiments, the axis of rotation of the magnets 6 may be substantially parallel to an axis of rotation of the wheels 2a of the vehicle 2.

The magnets 6 could be configured to rotate synchronously or asynchronously with the wheels 2a of the vehicle 2 when the magnets 6 are mounted to the vehicle 2.

The magnets 6 are arranged to rotate in a circular path.

The rotation of the magnets 6 may be in the clockwise direction or the anti-clockwise direction.

The apparatus 1 is a rugged, vibration-resistant, rigid apparatus 1.

A further embodiment of the invention will now be described, with reference to FIG. 8. In this embodiment, the apparatus 1 comprises a traction assistance device 30 operable to increase the traction of the wheel(s) 2a of the vehicle 2 to the track 4. The traction assistance device 30 is operable to apply a traction agent 32 to at least a portion of the wheel 2a of the vehicle 2, specifically to at least a portion of the wheel 2a that is, in use, in contact with the track 4.

The traction assistance device 30 is arranged to be spaced apart from the wheel 2a of the vehicle 2 along the z-axis 2z of the vehicle 2. The traction assistance device 30 is located adjacent to the wheel 2a of the vehicle 2 and is fixedly attached to the vehicle 2, such that, in use, the wheel 2a of the vehicle 2 moves relative to the traction assistance device 30.

The magnets 6 of the apparatus 1 are operable to attract the traction agent 32 to the wheel 2a of the vehicle 2 and to adhere the traction agent 32 to the wheel 2a of the vehicle 2. In this embodiment, the magnets 6 are typically all permanently activated, to retain the traction agent 32 close to the wheel 2a.

The traction agent 32 is configured to increase the contact friction of the wheel 2a of the vehicle 2 to the track 4, when the traction agent 32 is located on the wheel 2a of the vehicle 2. The traction agent 32 is configured to increase the surface area of at least one surface of the wheel 2a of the vehicle 2 when located thereon. The traction agent 32 is configured to increase the surface roughness of at least one surface of the wheel 2a of the vehicle 2 when located thereon.

The traction agent 32 is typically fine ferrous material, although a wide range of suitable materials can be used. For example, the traction agent 32 could include one or more fluids, and any mixture of solids, liquids and gases, although in this embodiment a solid fluid is used (fine ferrous material).

The traction agent 32 is configured to increase the magnetic coupling between the wheel 2a of the vehicle 2 and the track 4 when the traction agent 32 is located on the wheel 2a. This improves the magnetic friction of the apparatus 1, in addition to roughening the surface of the wheel 2a.

The traction assistance device 30 is connectable to a source of the traction agent 34, which could be a bucket, tank, reservoir, or the like.

The traction assistance device 30 is operable to remove the traction agent 32 from the upper region 2c of the wheel 2a of the vehicle 2.

In the embodiment shown here, the traction assistance device 30 comprises one or more electromagnets 36 operable to apply and/or remove the traction agent 32 to or from the wheel 2a of the vehicle 2, by attracting or repelling the traction agent 32 to, or from, the wheel 2a.

The magnets 6 of the apparatus 1 are operable to repel the traction agent 32 from the wheel 2a of the vehicle 1. For example, when the traction agent 32 is no longer required, such as at high speed, the traction agent 32 can be removed by the magnets 6. New traction agent 32 can be applied to the wheel 2a.

The traction assistance device 30 comprises a body portion 38 including one or more concave faces 38a arranged opposite the wheel 2a of the tread portion 2d of the wheel 2a of the vehicle 2.

Modifications or improvements may be made to the foregoing without departing from the scope of the invention.

For example, although the embodiments illustrated above show a vehicle 2 and a wheel 2a thereof, other embodiments of the invention could provide an apparatus 1 for applying a force to a structure, the apparatus 1 comprising one or more magnets, the one or more magnets 6 being rotatably mountable with respect to at least part of a structure. The structure could be locatable on or adjacent to an object, the object comprising one or more electrically conductive portions. The magnets 6 could be configured such that their rotation relative to the object induces one or more electrical currents in the object, the, or each electrical current creating a magnetic field, such that a force is applied to the structure. It will be appreciated that a wide range of structures and objects could be used.

While in the embodiments illustrated here the track 4 is a rail member, the track 4 could include any form of track or surface that a vehicle may traverse or follow, including railway tracks or rails, roads, paths, guides, guide members or guide rails, runway for aircraft, tracks for robotic vehicles, and tram lines.

The vehicle 2 could be configured to run on, or adjacent to the track 4.

The vehicle 2 could be a railway locomotive, a carriage of a rail vehicle, a tram, street car, or the like, a fuel-powered vehicle, an electric vehicle, a fuel-powered and/or electric vehicle, or a hybrid vehicle. The vehicle 2 could be configured to run on at least a portion of the track 4 and run adjacent to at least another portion of the track 4.

The vehicle 2 could be an aircraft, aerial vehicle, or the like. The track 4 may form at least a part of a runway for the aircraft, aerial vehicle, or the like. The vehicle 2 could be operable to hover above the track 4. The vehicle 2 could be operable to take off from, and/or land on, at least a portion of the track 4.

The vehicle 2 could be a robot, robotic device, robotic system, autonomous vehicle, or the like. The vehicle 2 could be a robotic vehicle.

Although the track 4 has been illustrated as being substantially flat, the track 4 could include one or more inclined portions, sloped portions, undulating portions, ramped portions, and/or flat portions. For example, the track 4 could include flat portions and sloped portions.

The vehicle 2 could be an automotive vehicle. The track 4 could form part of a road surface.

Although not described above, the apparatus 1 could be operable to accelerate the vehicle 2 from a stationary position and to decelerate the vehicle to a stationary position.

Although the apparatus 1 described above is illustrated as inducing eddy currents in the track 4, it will be understood that depending on the properties of the apparatus 1, vehicle 2 and track 4, the apparatus 1 could induce a different type of electrical current in the track 4.

It will be appreciated that permanent magnets, or a combination of permanent magnets and electromagnets, or other types of magnets, could be used in other embodiments of the invention.

In other embodiments, the vehicle 2 could be operable to fly, hover, or levitate above the track in the direction of the x-axis, y-axis and/or z-axis.

In other embodiments, the control system 14 could be integrated with a control system of the vehicle 2.

The source of electrical power could be obtained from one or more generator systems, either track side or on board the vehicle 2, or from energy storage devices, such as batteries. Other suitable sources of electrical power can be used, including d.c. power sources. The power management module 14c could comprise a power conversion device operable to convert d.c. electrical power to a.c. electrical power, or vice versa. The power conversion device could include an inverter, a power inverter, a rectifier, or the like.

The apparatus 1 may be configured to apply the same electrical phase to each magnet 6 (single phase mode).

At least one magnet 6 could be configured to provide a static magnetic field. A plurality of magnets 6 could be configured to provide a static magnetic field. All of the magnets 6 could be configured to provide a static magnetic field.

The apparatus 1 could include one or more magnets 6 arranged in a Halbach array.

The control system 14 could be operable to move the magnets 6 between a first position and a second position. For example, the apparatus 1 could comprise one or more permanent magnets, which could be moveable.

Although in the embodiments illustrated and described here, the, or each, magnet 6 is fully rotatable about the axis of rotation, in other embodiments, the magnets 6 could be at least partially pivotably mountable with respect to at least a part of the vehicle 2. In this arrangement, the magnet(s) 6 are partially pivotable about the axis of rotation, or are fully pivotable or rotatable about the axis of rotation.

In the embodiment illustrated in FIG. 8, the traction assistance device 30 could comprise one or more fluid transfer devices operable to apply and/or remove the traction agent 32 to or from the wheel 2a of the vehicle 2. The fluid transfer device(s) could include one or more nozzles, orifices, holes, or the like, for dispensing and/or collecting the traction agent 32. This could be in addition to the electromagnet 36, or as an alternative embodiment.

The apparatus 1 could comprise a plurality of traction assistance devices 30. Each traction assistance device 30 could be operable to apply and/or remove the traction agent 32 to or from the wheel 2a of the vehicle 2. In this arrangement, the apparatus 1 could comprise separate traction assistance devices 30 for applying and removing the traction agent 32.

1-29. (canceled)

30. An apparatus for applying a force to a vehicle on a track, the apparatus comprising:
one or more magnets, the one or more magnets being rotatably mountable with respect to at least part of the vehicle;
wherein the track comprises one or more electrically conductive portions; and
wherein the magnets are configured such that their rotation relative to the track induces one or more electrical currents in the track, such that a force is applied to the vehicle.

31. The apparatus of claim 30, wherein the apparatus is operable to vary the magnetic field strength of the, or each, magnet.

32. The apparatus of claim 30, wherein the apparatus is operable to switch the magnetic polarity, or to move the location of the poles, of the, or each, magnet.

33. The apparatus of claim 30, wherein the apparatus is operable to configure the, or each, magnet between an on state, in which the magnet produces a magnetic field, and the off state, in which the magnet does not produce a magnetic field.

34. The apparatus of claim 33, wherein the apparatus comprises one or more activation zones and one or more deactivation zones, the, or each, activation zone and the, or each, deactivation zone(s) being defined by sectors of a plane of rotation of the magnet, or magnets, the apparatus being operable to configure the magnet(s) to be in the on state when located in an activation zone and to be in the off state when located in a deactivation zone.

35. The apparatus of claim 34, wherein the activation zone, or zones, is located at a region of the vehicle that is, in use, adjacent to at least a portion of the track, and/or wherein the activation zone, or zones, is located at a lower region of the vehicle or a lower region of a wheel of the vehicle.

36. The apparatus of claim 34, wherein the apparatus is configured such that the, or each, magnet is activated for a shorter period of time than it is deactivated.

37. The apparatus of claim 30, wherein at least one of the magnet(s) is an electromagnet.

38. The apparatus of claim 37, wherein the apparatus comprises a control system, wherein the control system comprises one or more selection devices operable to selectively provide electrical power to at least one of the one or more magnets.

39. The apparatus of claim 38, wherein the apparatus is operable to change the location of at least one of the activation zone(s) and at least one of the deactivation zone(s).

40. The apparatus of claim 39, wherein the, or each, activation zone is associated with a phase line of an electrical power supply of the apparatus, such that when a magnet is located in a particular activation zone, that activation zone's associated phase line will be applied to that magnet.

41. The apparatus of claim 38, wherein the control system is configured to switch the, or each, magnet between at least a first phase of electrical power to a second phase of electrical power.

42. The apparatus of claim 30, wherein the apparatus comprises a frame member, wherein the, or each magnet, is located on the frame member, and wherein the frame member is integrally formed with a wheel of the vehicle.

43. The apparatus of claim 30, wherein the apparatus comprises a traction assistance device operable to increase the traction of a wheel of the vehicle to the track, wherein the traction assistance device is operable to apply a traction agent to at least a portion of a wheel of the vehicle and/or to at least a portion of the track.

44. The apparatus of claim 43, wherein the, or each, magnet of the apparatus is operable to attract the traction agent to the wheel of the vehicle.

45. The apparatus of claim 30, wherein the apparatus is operable to provide an attractive and/or repulsive force between the vehicle and the track.

46. The apparatus of claim 30, wherein:
the apparatus is operable to receive data from one or more sensor devices, wherein the one or more sensor devices are locatable on the vehicle and wherein the one or more sensor devices are configured to detect at least one property of the vehicle, one or more wheels thereof, and/or the track; and
the apparatus is configured to communicate with the one or more sensor devices wirelessly.

47. A method of applying a force to a vehicle, the method comprising the steps of:
providing an apparatus for applying a force to a vehicle on a track;
wherein the apparatus comprises:
one or more magnets, the one or more magnets being rotatably mountable with respect to at least part of the vehicle;
wherein the track comprises one or more electrically conductive portions; and
wherein the magnets are configured such that their rotation relative to the track induces one or more electrical currents in the track, the, or each electrical current creating a magnetic field, such that a force is applied to the vehicle;
rotatably mounting the one or more magnets with respect to at least part of the vehicle; and
using the apparatus to rotate the one or more magnets with respect to at least a part of the vehicle.

48. A vehicle comprising the apparatus of claim 30.

49. An apparatus for applying a force to a vehicle on a track, the apparatus comprising:
one or more magnetic elements being mountable with respect to at least part of the vehicle;
wherein the track comprises one or more electrically conductive portions; and
wherein the magnets are configured such that they induce one or more electrical currents in the track, the, or each electrical current creating a magnetic field, such that a force is applied to the vehicle.
